(19) United States
(12) Patent Application Publication
(10) Pub. No.: US 2005/0195254 A1
(43) Pub. Date: Sep. 8, 2005

(54) Ink cartridges and methods of filling ink cartridges

(75) Inventors: Atsuhiro Takagi, Kariya-shi (JP); Toyonori Sasaki, Anjo-shi (JP)

Correspondence Address: OLIFF & BERRIDGE, PLC, P.O. BOX 19928, ALEXANDRIA, VA, 22320, US

(73) Assignee: BROTHER KOGYO KABUSHIKI KAISHA, Nagoya-shi (JP)

(21) Appl. No.: 11/068,929

(22) Filed: Mar. 2, 2005

(30) Foreign Application Priority Data
Mar. 4, 2004 (JP) 2004-060457
Mar. 17, 2004 (JP) 2004-076626

(51) Int. Cl. B41J 2/175

(52) U.S. Cl. 347/85

(57) ABSTRACT

Methods for filling an ink cartridges having a cartridge body including an ink tank, an ink inflow passage that communicates with the ink tank at a first end through a first opening and that communicates with an exterior of the ink cartridge at a second end through a second opening, and a sealing member that is positioned in the ink inflow passage, are provided. An ink cartridge includes a cartridge body, an ink tank formed in the cartridge body for storing ink, and an ink inflow passage formed in the cartridge body for filling the cartridge. The ink inflow passage communicates with the ink tank at a first end through a first opening and communicates with an exterior of the cartridge at a second end through a second opening, the ink inflow passage includes a first region adjacent to the first opening and a second region adjacent to the second opening, and the first region has a smaller diameter than the second region.

### CROSS-REFERENCE TO RELATED APPLICATIONS

This application claims priority from JP 2004-060457, filed Mar. 4, 2004, and JP 2004-076626, filed Mar. 17, 2004, the disclosures of which are incorporated herein by reference in their entireties.

### BACKGROUND

The invention relates to ink cartridges and methods of filling ink cartridges.

Inkjet printers that perform printing by ejecting ink from nozzles toward a recording sheet may be provided with ink cartridges. Such ink cartridges are generally replaced and disposed of after the ink contained therein has been consumed. By using ink cartridges, ink can be easily replenished in the inkjet printer. However, spent ink cartridges are disposed of every time ink contained therein has been consumed, which may lead to increased operating costs. Thus, JP 3453562 discloses a technique including drilling a hole in a wall of an ink cartridge in which ink has been consumed and refilling the ink cartridge through the hole.

According to the technique disclosed in JP 3453562, a hole is drilled in a side wall of an ink cartridge, ink is introduced into the ink cartridge through the hole, and then the hole is sealed when filling is complete. However, if drilling or sealing is done improperly, ink may leak from the hole during operation. As such processes must be performed with considerable care, they may be troublesome for users.

Ink cartridges may be formed with ink chambers into which ink is introduced from outside using an ink syringe. As an example of this arrangement, JP-A-2003-305865 discloses attaching a synthetic rubber plug member to an ink fill portion where an ink fill hole is formed. To fill the cartridge with ink, an injection needle of an ink syringe is inserted through the plug member, and ink is introduced into the ink cartridge via the injection needle. A hole, which is formed in the plug member when the injection needle is inserted, closes to some extent by virtue of the plug member's elasticity after the injection needle is removed.

In the ink cartridge disclosed in JP-A-2003-305865, however, the hole formed in the plug member when the needle is inserted may not be closed perfectly by the elasticity of the plug member, depending on how the needle is inserted. In such cases, ink may leak from the hole or air and impurities may be introduced to the cartridge through the hole. Also, if it is necessary to insert an additional needle into the ink cartridge during filling, for example for deaeration, the filling needle and the additional needle may be inserted into similar positions on the plug member producing a comparatively large hole. It may be difficult to seal such a large hole relying only on the elasticity of the plug member.

### SUMMARY

In various exemplary embodiments, methods of filling an ink cartridge having a cartridge body including an ink tank, an ink inflow passage that communicates with the ink tank at a first end through a first opening and that communicates with an exterior of the ink cartridge at a second end through a second opening, and a sealing member that is positioned in the ink inflow passage, are provided. In various exemplary embodiments, such methods include: reducing a pressure in the ink tank, inserting an ink supply tube through the sealing member and into a first region in the ink inflow passage adjacent to the first opening, and allowing ink to be drawn through the ink supply tube, through the first opening, and into the ink tank.

In various exemplary embodiments, methods of filling an ink cartridge having a cartridge body including an ink tank, an ink inflow passage that communicates with the ink tank at a first end through a first opening and that communicates with an exterior of the ink cartridge at a second end through a second opening, and a sealing member that is positioned in the ink inflow passage, are provided. In various exemplary embodiments, such methods include: opening an air communication path to allow communication between the ink tank and the exterior of the ink cartridge, inserting an ink supply tube through the sealing member and into a first region in the ink inflow passage adjacent to the first opening, and pumping ink through the ink supply tube, through the first opening, and into the ink tank.

In various exemplary embodiments, methods of filling an ink cartridge having a cartridge body including an ink tank, an ink inflow passage that communicates with the ink tank at a first end through a first opening and that communicates with an exterior of the ink cartridge at a second end through a second opening, and a sealing member that is positioned in the ink inflow passage, are provided. In various exemplary embodiments, such methods include: inserting an air communication tube through the sealing member and into a first region in the ink inflow passage adjacent to the first opening, inserting an ink supply tube through the sealing member and into the first region, and pumping ink through the ink supply tube, through the first opening, and into the ink tank.

In various exemplary embodiments, methods of filling an ink cartridge having a cartridge body including an ink tank, an ink inflow passage that communicates with the ink tank at a first end through a first opening and that communicates with an exterior of the ink cartridge at a second end through a second opening, and a sealing member that is positioned in the ink inflow passage, are provided. In various exemplary embodiments, such methods include: removing the sealing member from the ink inflow passage, and dispensing ink into the ink inflow passage, through the first opening, and into the ink tank.

In various exemplary embodiments, methods of filling an ink cartridge having a cartridge body including an ink tank, an ink inflow passage that communicates with the ink tank at a first end through a first opening and that communicates with an exterior of the ink cartridge at a second end through a second opening, the ink inflow passage including a first region adjacent to the first end having a smaller diameter than a second region adjacent to the second end, and a sealing member that is positioned in the ink inflow passage, are provided. In various exemplary embodiments, such methods include: moving the sealing member from the first region of the ink inflow passage to the second region of the ink inflow passage, opening an air communication path between the ink tank and an exterior of the ink cartridge, inserting an ink supply tube through the sealing member and into the first region, pumping ink through the ink supply tube and into the ink tank, removing the ink supply tube from the ink inflow passage, and moving the sealing member from the second region to the first region.

In various exemplary embodiments, ink cartridges are provided, including a cartridge body, an ink tank formed in the cartridge body for storing ink, and an ink inflow passage formed in the cartridge body for filling the cartridge. In various exemplary embodiments, the ink inflow passage communicates with the ink tank at a first end through a first opening and communicates with an exterior of the cartridge at a second end through a second opening, the ink inflow passage includes a first region adjacent to the first opening and a second region adjacent to the second opening, and the first region has a smaller diameter than the second region.

These and other optional features and possible advantages of various aspects of this invention are described in, or are apparent from, the following detailed description of exemplary embodiments of systems and methods which implement this invention.

### BRIEF DESCRIPTION OF THE DRAWINGS

Various exemplary embodiments of the invention will be described in detail with reference to the following figures, wherein:

FIG. 1 is a schematic illustration of an exemplary inkjet printer according to this invention in which exemplary ink cartridges are installed;

FIG. 2A is a plan view of an exemplary ink cartridge according to this invention;

FIG. 2B is a side view of an exemplary ink cartridge according to this invention;

FIG. 2C is a bottom view of an exemplary ink cartridge according to this invention;

FIG. 3 is a perspective view of an exemplary ink cartridge according to this invention;

FIG. 4 is a sectional view of the ink cartridge shown in FIG. 2B, taken along the line IV-IV;

FIG. 5A is a sectional view of the ink supply valve shown in FIG. 4 in a closed state;

FIG. 5B is a sectional view of the ink supply valve shown in FIG. 4 in an open state;

FIG. 6 is a perspective view of the valve body shown in FIG. 4;

FIG. 7 is a sectional view of an exemplary ink cartridge showing a phase of an exemplary ink filling method according to this invention;

FIG. 8 is a sectional view of an exemplary ink cartridge showing a phase of an exemplary ink filling method according to this invention;

FIG. 9 is a sectional view of an exemplary ink cartridge showing a phase of an exemplary ink filling method according to this invention;

FIG. 10 is a sectional view of an exemplary ink cartridge showing a phase of an exemplary ink filling method according to this invention;

FIG. 11 is a sectional view of an exemplary ink cartridge showing a phase of an exemplary ink filling method according to this invention;

FIG. 12 is a sectional view of an exemplary ink cartridge showing a phase of an exemplary ink filling method according to this invention;

FIG. 13 is a sectional view of an exemplary ink cartridge showing a phase of an exemplary ink filling method according to this invention;

FIG. 14 is a sectional view of an exemplary ink cartridge showing a phase of an exemplary ink filling method according to this invention;

FIG. 15 is a sectional view of an exemplary ink cartridge showing a phase of an exemplary ink filling method according to this invention;

FIG. 16 is a sectional view of an exemplary ink cartridge showing a phase of an exemplary ink filling method according to this invention;

FIG. 17 is a sectional view of an exemplary ink cartridge showing a phase of an exemplary ink filling method according to this invention;

FIG. 18 is a sectional view of an exemplary ink cartridge showing a phase of an exemplary ink filling method according to this invention;

FIG. 19 is a sectional view of an exemplary ink cartridge showing a phase of an exemplary ink filling method according to this invention;

FIG. 20 is a sectional view of an exemplary ink cartridge showing a phase of an exemplary ink filling method according to this invention;

FIG. 21 is a sectional view of an exemplary ink cartridge showing a phase of an exemplary ink filling method according to this invention;

FIG. 22 is a sectional view of an exemplary ink cartridge showing a phase of an exemplary ink filling method according to this invention;

FIG. 23 is a sectional view of an exemplary ink cartridge according to this invention;

FIG. 24 is an enlarged view of a portion of the ink cartridge shown in FIG. 23;

FIG. 25A is a plan view of an exemplary ink cartridge according to this invention;

FIG. 25B is a side view of an exemplary ink cartridge according to this invention;

FIG. 25C is a bottom view of an exemplary ink cartridge according to this invention;

FIG. 26 is a perspective view of an exemplary ink cartridge according to this invention, as viewed from below;

FIG. 27 is a sectional view of the ink cartridge shown in FIG. 25B, taken along the line IV-IV;

FIG. 28 is an enlarged view of a portion of the ink cartridge shown in FIG. 27;

FIG. 29A is a partial sectional view of an exemplary ink cartridge showing a phase of an exemplary ink filling method according to this invention;

FIG. 29B is a partial sectional view of an exemplary ink cartridge showing a phase of an exemplary ink filling method according to this invention;

FIG. 29C is a partial sectional view of an exemplary ink cartridge showing a phase of an exemplary ink filling method according to this invention;

FIG. 29D is a partial sectional view of an exemplary ink cartridge showing a phase of an exemplary ink filling method according to this invention;

FIG. 29E is a partial sectional view of an exemplary ink cartridge showing a phase of an exemplary ink filling method according to this invention;

FIG. 30A is a partial sectional view of an exemplary ink cartridge according to this invention; and

FIG. 30B is a partial sectional view of an exemplary ink cartridge according to this invention.

### DETAILED DESCRIPTION OF EMBODIMENTS

Throughout the following description, numerous specific concepts and structures are set forth in order to provide a thorough understanding of the invention. The invention can be practiced without utilizing all of these specific concepts and structures. In other instances, well known elements have not been shown or described in detail, so that emphasis can be focused on the invention.

In various exemplary embodiments, an ink cartridge includes an ink tank, an ink outflow passage through which ink stored in the ink tank may be dispensed, an air communication passage through which outside air may communicate with an interior of the ink tank, an ink inflow passage through which the ink can be provided to the ink tank, an ink valve capable of opening and closing the ink outflow passage, an air valve capable of opening and closing the air communication passage, and an elastic member sealing the ink inflow passage. In various exemplary embodiments, a method of filling an ink cartridge includes: reducing a pressure in the ink tank; inserting a filling tube through the elastic member to bring the tube into proximity with an ink passage provided in the ink cartridge at a position nearer to the ink tank than the elastic member; and filling the ink tank with ink via the tube. Accordingly, without modifying the ink cartridge, the cartridge can be easily filled with ink. In addition, the ink cartridge can be refilled, thereby reducing the operating costs.

In various exemplary embodiments, a method of filling an ink cartridge includes: positioning the ink cartridge so that ink is prevented from flowing into an air communication passage during filling; operating an air valve or ink valve on the cartridge to permit an ink tank of the ink cartridge to communicate with outside air; inserting a filling tube through an elastic member to bring the tube into proximity with an ink passage provided in the ink cartridge at a position nearer to the ink tank than the elastic member; and filling the ink tank with ink via the tube. Accordingly, without modifying the ink cartridge, the cartridge can be easily filled with ink. In addition, the ink cartridge can be refilled, thereby reducing the operating costs.

In various exemplary embodiments, a method of filling an ink cartridge includes: inserting a filling tube through the elastic member to bring the tube into proximity with an ink passage provided in the ink cartridge at a position nearer to the ink tank than the elastic member; inserting an air communication tube through the elastic member to bring a tip of the air communication tube including a communication opening into proximity with the ink passage provided in the ink cartridge at a position nearer to the ink tank than the elastic member; and filling the ink tank with ink via the filling tube. Accordingly, without modifying the ink cartridge, the cartridge can be easily filled with ink. In addition, the ink cartridge can be refilled, thereby reducing the operating costs.

In various exemplary embodiments, a method of filling an ink cartridge includes: positioning the ink cartridge so that ink is prevented from flowing into an ink inflow passage that communicates with an ink tank during filling; removing an elastic member from the ink inflow passage; filling the ink tank with ink via the ink inflow passage; and sealing the ink inflow passage after filling. Accordingly, without modifying the ink cartridge, the cartridge can be easily filled with ink. In addition, the ink cartridge can be refilled, thereby reducing the operating costs.

In various exemplary embodiments, a method of filling an ink cartridge includes: force-fitting an elastic member into a stepped portion formed in a middle of an ink inflow passage, the ink inflow passage communicating with an ink tank storing ink and an outside of the ink cartridge, the ink inflow passage having a portion nearer the ink tank from the stepped portion and a portion nearer the outside of the ink cartridge from the stepped portion, the portion nearer the ink tank from the stepped portion having a smaller diameter than the portion nearer the outside of the ink cartridge from the stepped portion; inserting an injection needle through the elastic member and filling the ink tank via the injection needle; and removing the injection needle from the elastic member and force-fitting the elastic member into the ink inflow passage until it is located in the portion nearer the ink tank from the stepped portion. By employing such a method, when the injection needle removed from the elastic member after filling and the elastic member is force-fitted into the ink inflow passage until it is located in the portion nearer the ink tank from the stepped portion, an increased compression force is applied to the elastic member by a sidewall of the ink inflow passage. As a result, a through hole formed in the elastic member by insertion of the injection needle can be reliably closed.

In various exemplary embodiments, an ink cartridge includes an ink tank suitable for storing ink; an ink inflow passage that communicates with the ink tank and an outside of the ink cartridge; and an elastic member that is force-fitted into the ink inflow passage and closes the ink inflow passage. In various exemplary embodiments, a stepped portion is formed in a middle of the ink inflow passage, and a diameter of the ink inflow passage at a portion nearer the ink tank than the stepped portion is smaller than a diameter of the ink inflow passage at a portion nearer the outside of the ink cartridge than the stepped portion. By employing such a configuration, a needle of an ink syringe can be inserted through the elastic member to introduce ink into the ink cartridge via the injection needle. When the injection needle is removed from the elastic member after filling, the elastic member is force-fitted into the ink inflow passage until it is located at the portion nearer the ink tank from the stepped portion. This force-fitting increases a compression force from the ink inflow passage acting on the elastic member. As a result, a through hole formed through the elastic member on insertion of the injection needle can be reliably closed.

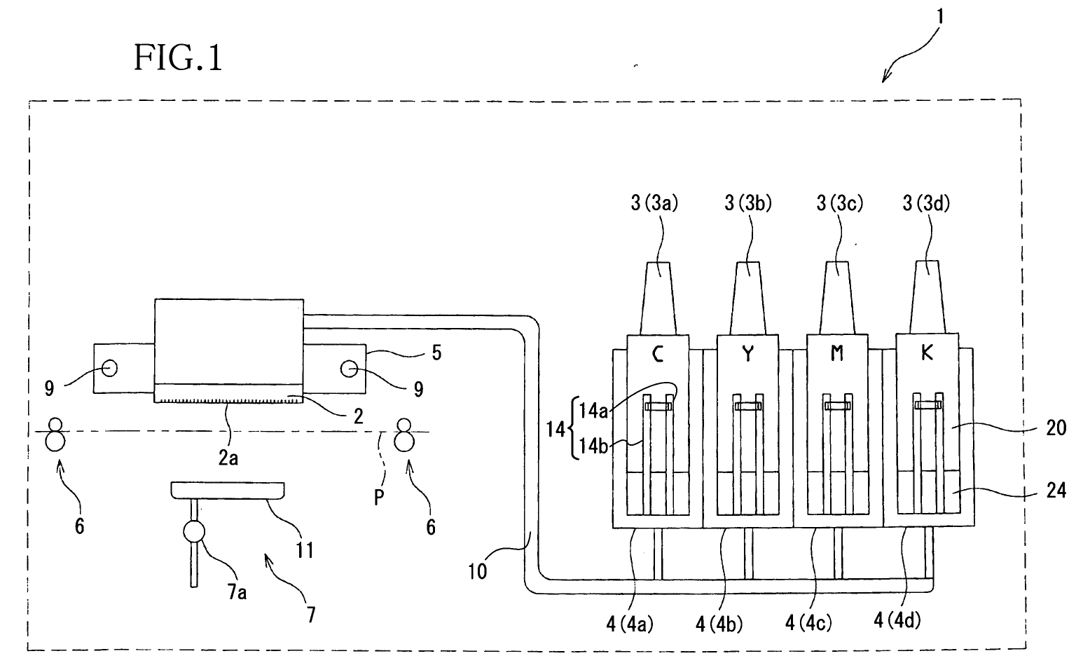

An exemplary embodiment of the invention will be described in detail below. Embodiments of the invention are applicable to an ink cartridge attachable to an inkjet printer that is capable of ejecting ink of four colors. As shown in FIG. 1, the inkjet printer 1 includes an inkjet head 2 having nozzles 2a that eject ink of four colors, cyan (C), yellow (Y), magenta (M), and black (K) onto a recording sheet P; four holders 4 (4a, 4b, 4c, and 4d) in which four ink cartridges 3 (3a, 3b, 3c, 3d) containing ink of one of the four colors respectively are installed; a carriage moving mechanism 5 that reciprocates the inkjet head 2 linearly in a direction along guides 9 (in a direction perpendicular to the drawing sheet); a conveying mechanism 6 that conveys the recording sheet P in a direction perpendicular to the moving direction of the inkjet head 2 and parallel to an ink ejection surface of the inkjet head 2; and a purge device 7 that suctions air bubbles and thick ink from the inkjet head 2.

In the inkjet printer 1, the inkjet head 2 is reciprocated by the carriage moving mechanism 5 in a direction perpendicular to the drawing sheet of FIG. 1, while the recording sheet P is conveyed by the conveying mechanism 6 in a left-right direction on the page in FIG. 1. Concurrently, ink is supplied from the ink cartridges 3 installed in the holders 4 via a supply tube 10 to the nozzles 2a of the inkjet head 2, and ink is ejected from the nozzles 2a toward the recording sheet P, so that printing is performed on the recording sheet P.

The purge device 7 includes a purge cap 11 and a suction pump 7a. The purge cap 11 is movable in directions toward or away from the ink ejection surface and is detachably attachable to the inkjet head 2 so as to cover the ink ejection surface. The suction pump 7a suctions ink and/or air from the nozzles 2a. When the inkjet head 2 is located outside of an area where it can print on the recording sheet P, the purge device 7 is capable of suctioning air bubbles or ink having a high viscosity as a result of evaporation of volatile elements, trapped in the inkjet head 2 from the nozzles 2a by the action of the suction pump 7a.

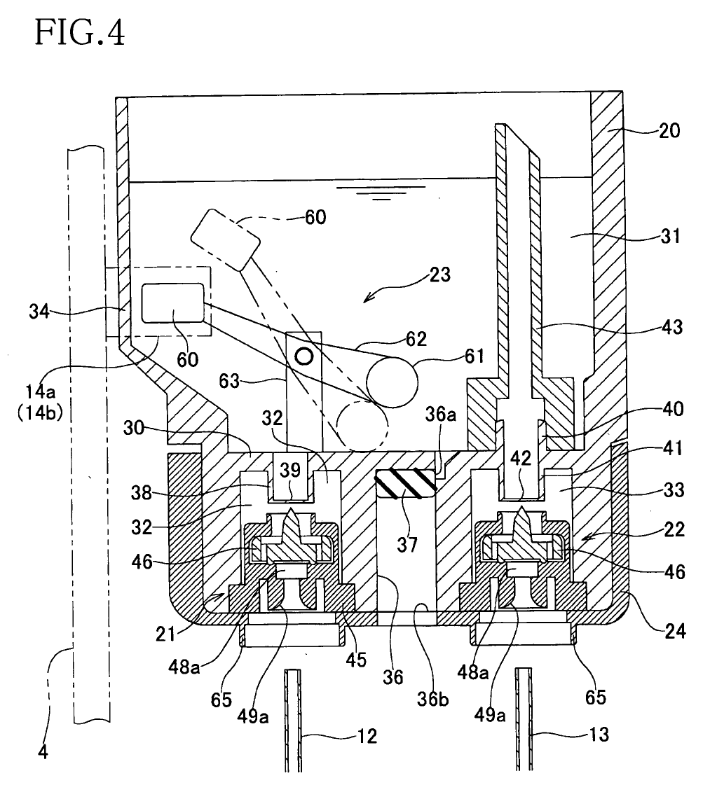

The four holders 4a to 4d are arranged in a line and attached to the corresponding ink cartridges 3a to 3d each storing one of cyan, yellow, magenta, and black inks, respectively. At a bottom portion of each holder 4, an ink extraction tube 12 and an air introducing tube 13 (FIG. 4) are disposed so as to correspond to an ink supply valve 21 and an air communication valve 22 in the ink cartridge 3. The holder 4 is also provided with an optical sensor 14 for detecting a remaining amount of ink (ink level) in the ink cartridge 3. The sensor 14 has a light emitting portion 14a and a light receiving portion 14b that are positioned at the same height in a face-to-face relationship with each other so as to sandwich at least a portion of the ink cartridge 3 therebetween. The sensor 14 detects whether light from the light emitting portion 14a is interrupted by a shutter mechanism 23 provided in the ink cartridge 3, and outputs the detection result to a control device (not shown) that governs operation of the inkjet printer 1.

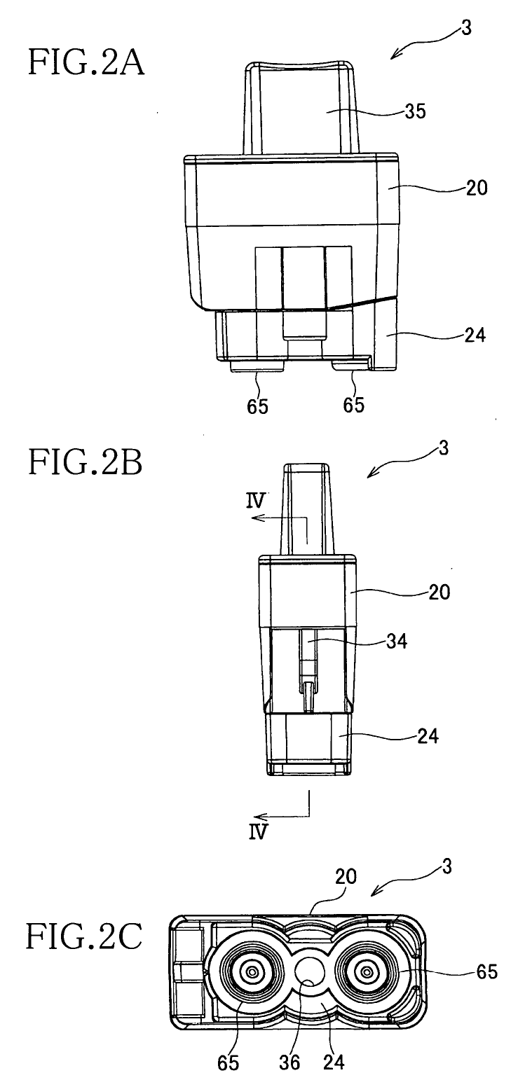

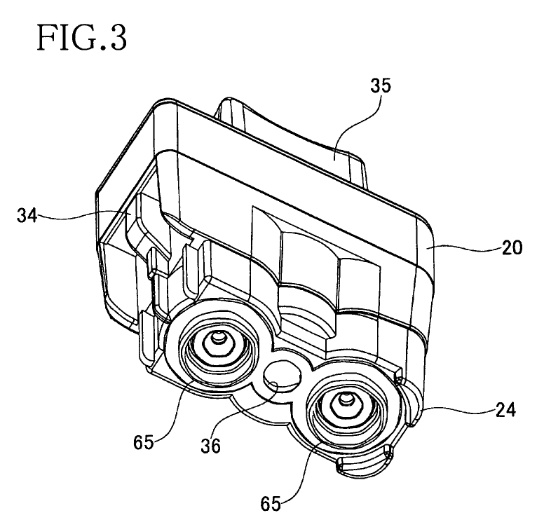

The ink cartridge 3 will be further described with reference to FIGS. 2-7. As the ink cartridges 3a-3d are identical in shape, structure and operation with each other, except that each contains a different color of ink, the following description will be made with respect to one ink cartridge.

As shown in FIGS. 2-4, the ink cartridge 3 is provided with a cartridge body 20, the ink supply valve (ink valve) 21, the air communication valve (air valve) 22, a shutter mechanism 23, and a cap 24. The cartridge body 20 contains ink therein. The ink supply valve (ink valve) 21 is capable of opening and closing an ink supply passage through which ink in the cartridge body 20 is supplied to the ink jet head 2. The air communication valve 22 is capable of opening and closing an air introducing passage through which air can be transmitted to the cartridge body 20 from outside of the cartridge 3. The shutter mechanism 23 obstructs light emitted by the light emitting portion 14a of the sensor 14 to detect an ink level. The cap 24 covers a lower end portion of the cartridge body 20.

The cartridge body 20 may be made of a synthetic resin having light permeability. As shown in FIG. 4, a partition wall 30 that extends horizontally is integrally formed with the cartridge body 20. The partition wall 30 divides an internal space of the cartridge body 20 into an ink chamber (ink tank) 31, which is situated above the partition wall 30, and two valve chambers 32 and 33, which are situated below the partition wall 30. Ink is stored in the ink chamber 31. The ink supply valve 21 and the air communication valve 22 are accommodated in the valve chambers 32, 33, respectively.

As shown in FIG. 2B, a protruding portion 34, which protrudes outwardly, is formed at a substantially central portion of a side of the cartridge body 20 with respect to its height. A light-shielding plate 60 of a shutter mechanism 23 is disposed in a space defined by the protruding portion 34. With the ink cartridge 3 attached to the holder 4, the protruding portion 34 is sandwiched between the light emitting portion 14a and the light-receiving portion 14b of the sensor 14. A lid member 35 is welded at an upper end portion of the cartridge body 20, to enclose the ink chamber 31 in the cartridge body 20.

As shown in FIG. 4, an ink fill hole 36 for introducing ink to the ink chamber 31 of the ink cartridge 3 is formed between the two valve chambers 32, 33. The ink fill hole 36 communicates with the ink chamber 31 in the cartridge body 20 via an upper opening 36a and communicates with the outside via a lower opening 36b. A sealing or plug member 37, such as an elastic (e.g., synthetic rubber) plug member, is force-fitted into an upper end of the ink fill hole 36. The plug member 37 is cylindrical and seals the opening 36a at its peripheral side surface.

A tubular portion 38, which protrudes downward, is integrally formed with a portion of the partition wall 30 that forms a top portion of the valve chamber 32 where the ink supply valve 21 is accommodated. The tubular portion 38 is provided, at its lower end, with a thin film portion 39 that closes a passage formed in the tubular portion 38. Tubular portions 40, 41, which protrude upward and downward, respectively, are integrally formed with the partition wall 30 that forms a top portion of the valve chamber 33 where the air communication valve 22 is accommodated. The lower tubular portion 41 is provided with a thin film portion 42 that closes passages formed in the tubular portions 40, 41 at a lower end. The tubular portion 40 is provided, at its upper end, with a tubular member 43 that extends to the upper end of the ink chamber 31.

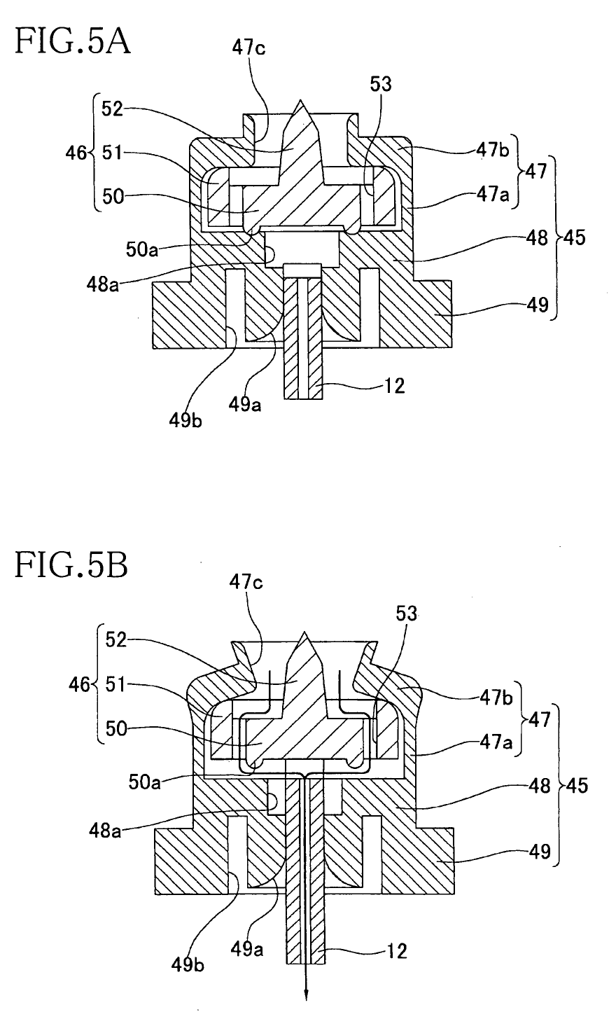

As shown in FIGS. 4, 5A and 5B, the ink supply valve 21 includes a valve housing 45 and a valve body 46. The valve housing 45 may be made of a synthetic rubber, and is formed in a substantially tubular shape and has elasticity. The valve body 46 may be made of a synthetic resin and is accommodated in the valve housing 45. The valve housing 45 includes an urging member 47, a valve seat 48, and an engaging portion 49, which are arranged in this order from the upper end (the ink chamber 31 side) and formed integrally.

A bottom surface of the valve body 46 makes contact with a top surface of the valve seat 48 (an end surface facing the ink chamber 31). A through hole 48a extending vertically is formed substantially in a central axis of the valve seat 48. The engaging portion 49 has a guide hole 49a that communicates with the through hole 48a and extends downwardly. The guide hole 49a is shaped such that its diameter becomes greater toward the bottom end. Around the guide hole 49a, a circular groove 49b is formed. The groove 49b allows a wall portion forming the guide hole 49a to deform elastically and easily toward a direction that the diameter of the guide hole 49a becomes greater. Thus, when the ink extraction tube 12 is inserted into the guide hole 49a, a sealing fit between the guide hole 49a and the ink extraction tube 12 is improved thereby preventing ink leakage as much as possible. Even if the ink extraction tube 12 is inserted into the guide hole 49a on a slant or is not completely inserted into the guide hole 49a, the ink extraction tube 12 can be inserted into the guide hole 49a with reliability because the wall portion forming the guide hole 49a deforms in a direction that causes the diameter of the guide hole 49a to become greater.

The urging member 47 has a side wall portion 47a and an overhang 47b. The side wall portion 47a extends from the outer surface of the valve seat 48 upwardly toward the ink chamber 31. The overhang 47b is integral with the side wall portion 47a and extends radially inward from the upper end of the side wall portion 47a. The bottom surface of the overhang 47b makes contact with the valve body 46, and the valve body 46 is urged downward by elastic force of the side wall portion 47a and the overhang 47b. In addition, an opening 47c is formed inside the overhang 47b, so that the side wall portion 47a and the overhang 47b, which are integrally formed, are easily deformed.

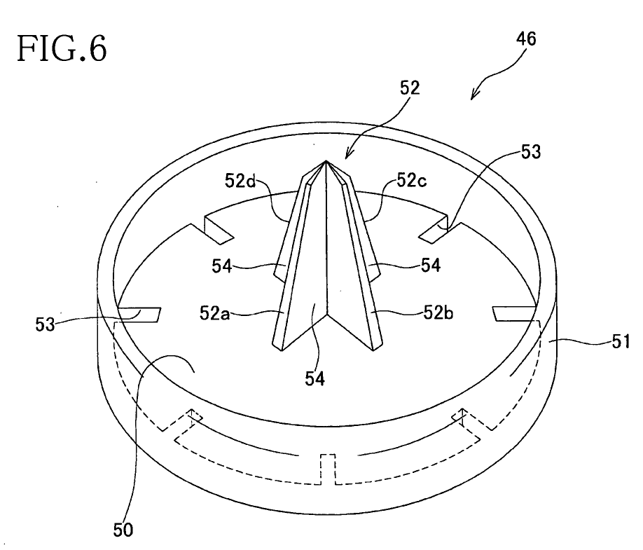

As shown in FIGS. 5A, 5B and 6, the valve body 46 has a bottom portion 50, a valve side wall portion 51, and a breaking portion 52. The bottom portion 50 makes contact with the valve seat 48. The valve side wall portion 51 is formed in a tubular shape and extends from the valve side wall portion 51 upward toward the ink chamber 31. The breaking portion 52 projects from a center of the bottom portion 50 toward the ink chamber 31 higher than the valve side wall portion 51.

An annular protrusion 50a that protrudes toward the valve seat 48 is formed at the bottom surface of the bottom portion 50 (which is an end surface facing the valve seat 48). In a state where the valve body 46 is urged toward the valve seat 48 by the urging member 47 and the annular protrusion 50a is in contact with the top surface of the valve seat 48, the through hole 48a of the valve seat 48 is closed by the valve body, and thus the ink supply passage is closed. Further, a plurality of passages (e.g. eight passages in this embodiment) 53 are formed at equal intervals in the bottom portion 50 in between the outside of the annular protrusion 50a and the inside of the valve side wall portion 51. The passages 53 provide communication between the upper space above the valve body 46 and the lower space below the valve body 46.

As shown in FIGS. 5A, 5B, and 6, the breaking portion 52 is made up of four plate-like members 52a, 52b, 52c, 52d that are assembled in the shape of a cross in a plan view, and is held upright relative to a substantially central portion of the bottom portion 50. Grooves 54 that extend vertically are formed between the four plate-like members 52a to 52d. The breaking portion 52 protrudes upwardly through the opening 47c inside of the overhang 47b such that its end is disposed at a place slightly lower than the thin film portion 39 as shown in FIG. 4.

When the ink cartridge 3 is attached to the holder 4, the ink extraction tube 12 is inserted into the guide hole 49a. The valve body 46 is pressed up by the tip of the ink extraction tube 12 against the urging force of the urging member 47. The valve body 46 moves upward while deforming the urging member 47, and the annular protrusion 50a is separated from the valve seat 48. At this time, the thin film portion 39 is broken by the end of the breaking portion 52 of the valve body 46 moving upward, so that ink in the ink chamber 31 flows into the valve chamber 32 via the passage in the tubular portion 38, as shown in FIGS. 4 and 5B. In addition, ink is supplied from the ink extraction tube 12 to the inkjet printer 1 via the passages 53 of the valve body 46.

As in the case of the ink supply valve 21 shown in FIGS. 5A and 5B, the air communication valve 22 also includes the valve housing 45 and the valve body 46 accommodated in the valve housing 45. That is, the air communication valve 22 is also structured so that the valve body 46 is urged downward by the urging member 47 and brought into intimate contact with the valve seat 48 of the valve housing 45 so as to close the through hole 48a. When the ink cartridge 3 is attached to the holder 4, the air introducing tube 13 is inserted into the guide hole 49a formed in the valve housing 45, the valve body 46 moves up and the thin film portion 42 of the tubular portion 41 is broken by the breaking portion 52. Subsequently, air flows into the valve chamber 33 from the air introducing tube 13 via the passages 53 of the valve body 46, and air is guided to an upper part of the ink chamber 31.

As shown in FIG. 4, the shutter mechanism 23 is disposed in a lower portion of the ink chamber 31, and includes the light-shielding plate 60, a hollow float 61, a connecting member 62 that connects the light-shielding plate 60 and the float 61, and a support stand 63 that pivotally supports the connecting member 62 disposed above the partition wall 30. The light-shielding plate 60 and the float 61 are provided at both ends of the connecting member 62. The connecting member 62 is disposed within a vertical plane parallel to the sheet of FIG. 4 so as to pivot on a central point of the support stand 63.

The light-shielding plate 60 is a thin plate in parallel with the vertical plane and having a specified area. With the ink cartridge 3 attached to the holder 4, the light emitting portion 14a and the light receiving portion 14b reach a height equal to the protruding portion 34 formed at a side wall portion of the cartridge body 20. When the light-shielding plate 60 is positioned in a space defined by the protruding portion 34, the light-shielding plate 60 prevents light emitted by the light emitting portion 14a of the sensor 14 from passing through a transparent wall portion of the cartridge body 20 and ink in the ink chamber 31. The float 61 is a cylindrical member filled with air, and its specific gravity is smaller than the specific gravity of ink in the ink chamber 31.

Thus, when the ink level in the ink chamber 31 is high and the float 61, which is provided at one end of the connecting member 62, is entirely submerged in ink, the float 61 floats toward the surface of the ink and the light-shielding plate 60, which is provided at the other end of the connecting member 62, is located at a position in the protruding portion 34 (a position indicated by a solid line in FIG. 4) such that light emitted by the light emitting portion 14a is prevented from passing through the protruding portion 34. On the other hand, when the ink level is decreased and a part of the float 61 starts to rise to the surface of the ink, buoyancy will cause the float 61 to descend with the ink level. At this time, the light-shielding plate 60 moves to a position higher than the protruding portion 34 (a position indicated by a chain line in FIG. 4) so that the light-shielding plate 60 does not prevent light emitted by the light emitting portion 14a from passing through the protruding portion 34. Thus, unobstructed by the light-shielding plate 60, light emitted by the light emitting portion 14a passes through the protruding portion 34 and ink in the ink chamber 31, and is received by the light receiving portion 14b. In this way, the low ink level is detected by the sensor 14.

As shown in FIGS. 2-4, the cap 24 is fixed to the cartridge body 20, for example, by ultrasonic welding to cover the lower end portion of the cartridge body 20. At the bottom of the cap 24, two annular protrusions 65 that protrude downwardly are formed at positions corresponding to the ink supply valve 21 and the air communication valve 22. By virtue of the annular protrusions 65, when the ink cartridge 3 is placed, for example, on a desk, ink adhered to outer surfaces of the ink supply valve 21 or the air communication valve 22 is less likely to be transferred to the surface of the desk.

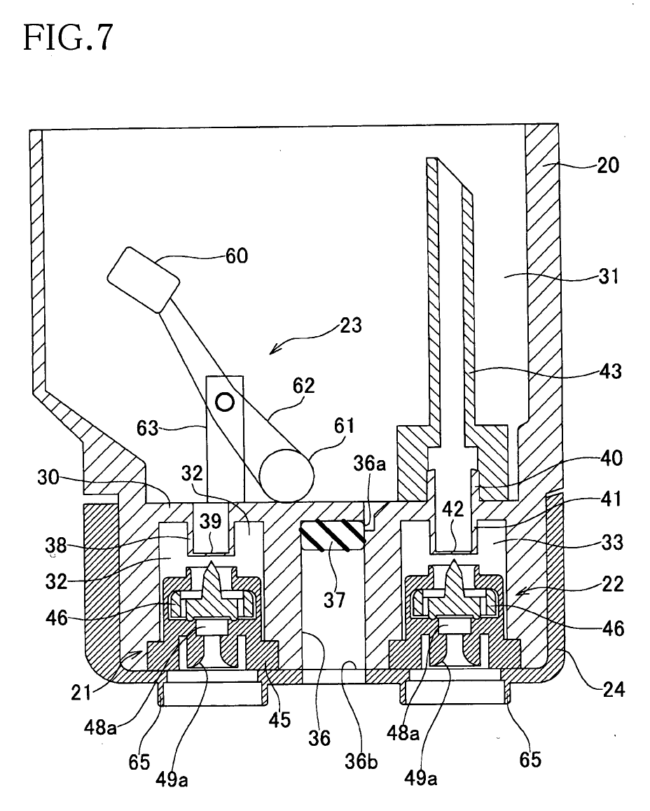

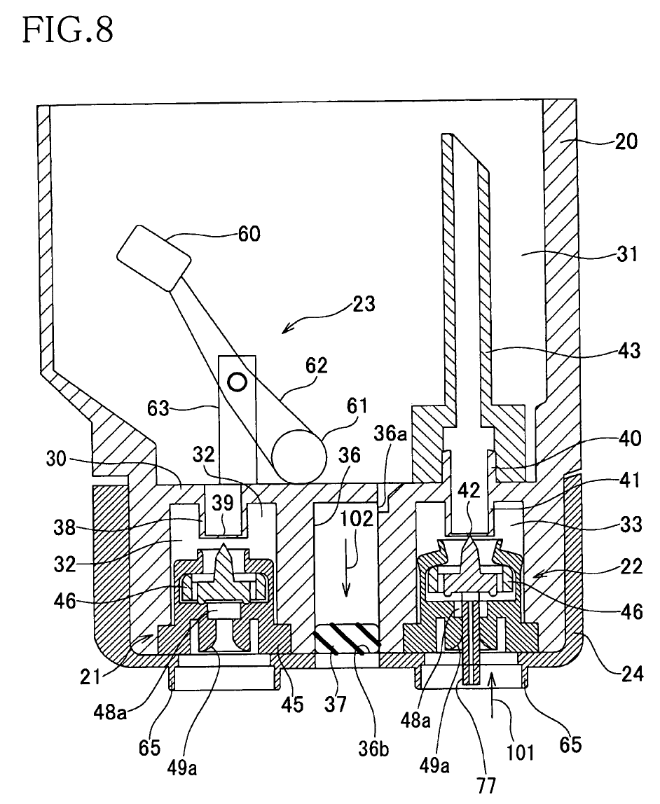

An exemplary method of filling an ink cartridge 3 where ink has been used up and the ink chamber 31 has become empty will be described with reference to FIGS. 7 to 11. As shown in FIG. 7, the ink cartridge 3 in which the ink chamber 31 has become empty is removed from the holder 4. To prevent ink from flowing in the valve chamber 33 via the tubular member 43 when ink is filled into the ink chamber 31, the ink cartridge 3 is positioned so that an opening of the tubular member 43 that communicates with the ink chamber 31 faces up. Then, as shown in FIG. 8, an air ventilation tube 77 is inserted into the guide hole 49a of the air communication valve 22 in a direction of an arrow 101, so that the air communication valve 22 is opened. Then, the plug member 37 disposed so as to seal the opening 36a of the ink fill hole 36 is separated away from the opening 36a in the direction of the arrow 102 and disposed near the opening 36b.

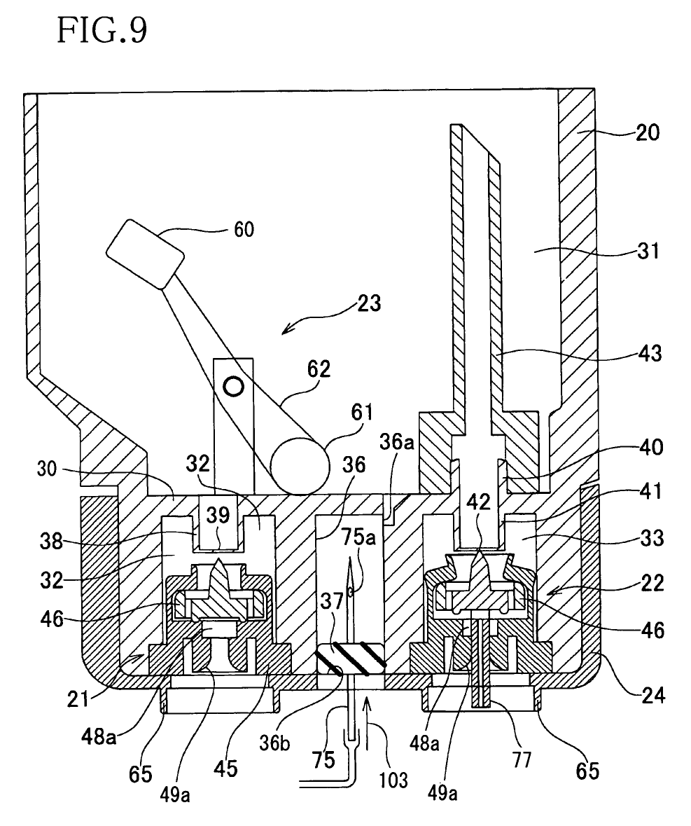

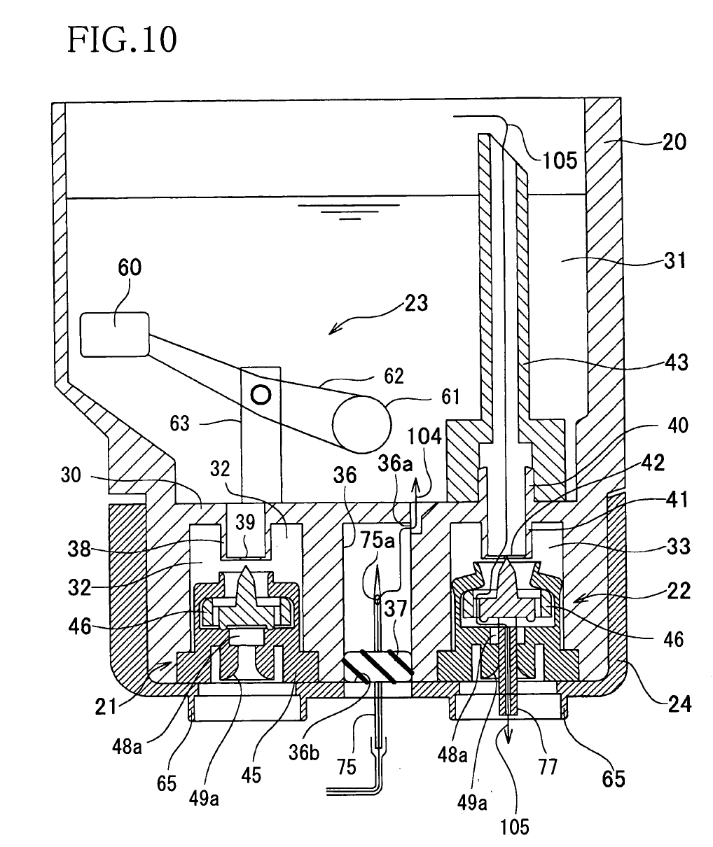

As shown in FIG. 9, an injection needle 75 of an ink syringe (not shown) is inserted into the plug member 37 in a direction of an arrow 103 such that the injection needle 75 passes through and is exposed from the top surface of the plug member 37. At this time, the injection needle 75 should be inserted until an ink outlet 75a formed near the tip of the injection needle 75 is positioned completely through the plug member 37 and toward the ink chamber 31. That is, the ink outlet 75a should be located nearer the ink chamber 31 than the plug member 37 is. Then the ink syringe is operated so that ink is introduced into the cartridge body 20. As shown in FIG. 10, the introduced ink passes through the inside of the injection needle 75 past the plug member 37 and is discharged into the ink fill hole 36 from the ink outlet 75a. The introduced ink flows in the ink chamber 31 through the opening 36a of the ink fill hole 36 (in a direction of an arrow 104). At this time, as shown by an arrow 105, air in the ink chamber 31 corresponding to an amount of the introduced ink is discharged from the ink chamber 31 through the air communication valve 22 and the air ventilation tube 77. When the ink chamber 31 has been filled to a desired level, filling with the ink syringe is stopped. The amount of the introduced ink is preferably an amount sufficient to cause the ink to reach a level near the opening of the tubular member 43 in the ink chamber 31, but not higher than the opening of the tubular member 43 (even if the ink level rises when the cartridge is resealed).

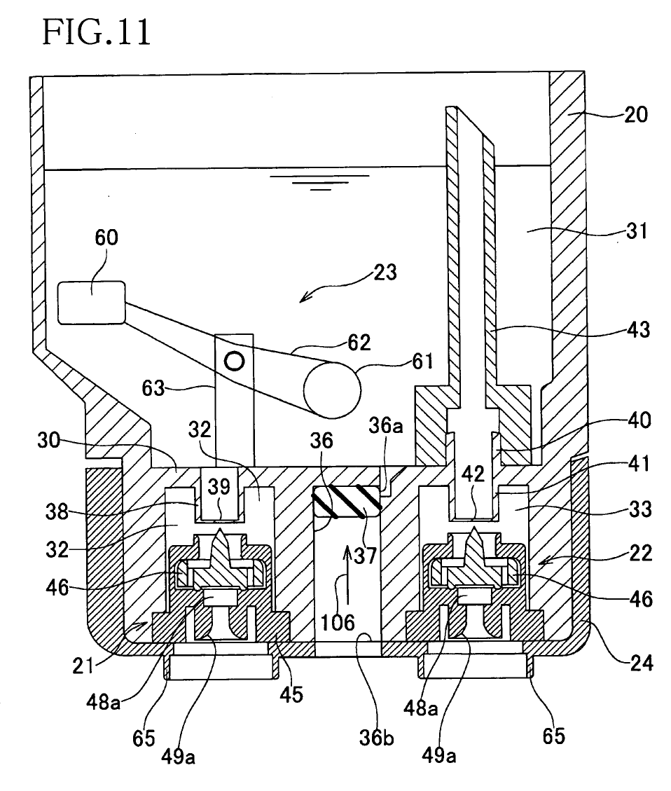

As shown in FIG. 11, the injection needle 75 is pulled out from the plug member 37. At this time, a through hole, which is formed in the plug member 37 after the injection needle 75 is inserted, is closed by elastic force inherent in the plug member 37. Thereafter, the plug member 37 disposed near the opening 36b is moved up to the upper end of the ink fill hole 36 in a direction of an arrow 106 so as to seal the opening 36a at its peripheral side surface. When sealing of the opening 36a is completed, the air ventilation tube 77 is pulled out from the guide hole 49a of the air communication valve 22, the air communication valve 22 is closed, and the filling is complete.

According to the embodiment shown in FIGS. 7-11, the ink chamber 31 can be easily filled with ink without modifying to the cartridge body 20. In addition, ink can be repeatedly supplied in the cartridge body 20, thereby allowing reuse of the cartridge body 20 and reducing the operating costs. The plug member 37 is separated from the opening 36a, so that ink can be easily filled through the ink fill hole 36 at a location nearer to the ink chamber 31 than the plug member 37.

In the embodiment shown in FIGS. 7-11, the plug member 37 seals the opening 36a at its peripheral side surface and the injection needle 75 of the ink syringe is exposed from the top surface of the plug member 37. With this construction, even when the injection needle 75 is inserted into the plug member 37 over and over again and the top and bottom end surfaces of the plug member 37 become fatigued, ink leakage from the ink fill hole 36 can be prevented at the peripheral side surface of the plug member 37, which is not fatigued. With this construction, the number of times that refilling can be performed is increased, and thus operating costs are reduced.

Removal of the air ventilation tube 77 is carried out after sealing with the plug member 37 is performed. Accordingly, a pressure increase associated with resealing does not occur, and a condition that might adversely affect ink meniscus formation at nozzles 2a does not occur. Accordingly, a stable ink supply is protected.

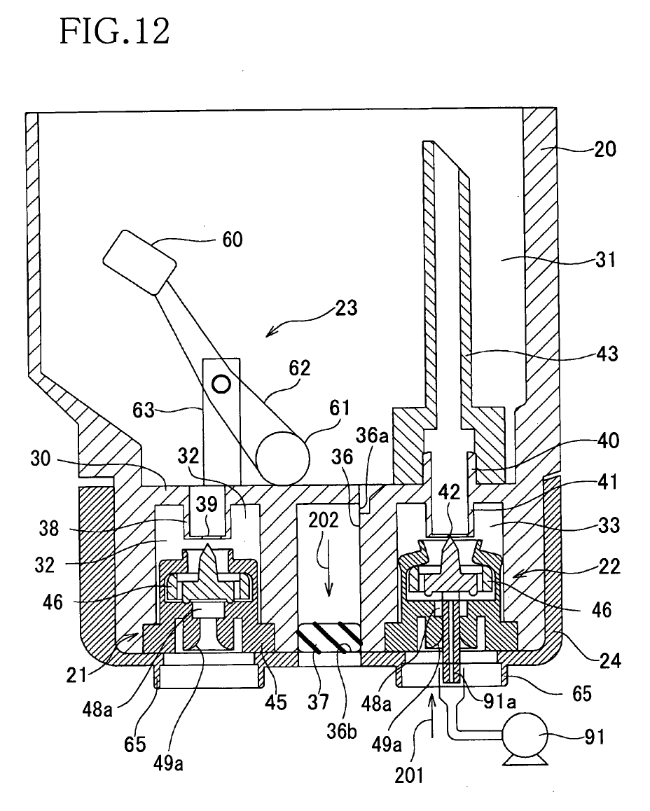

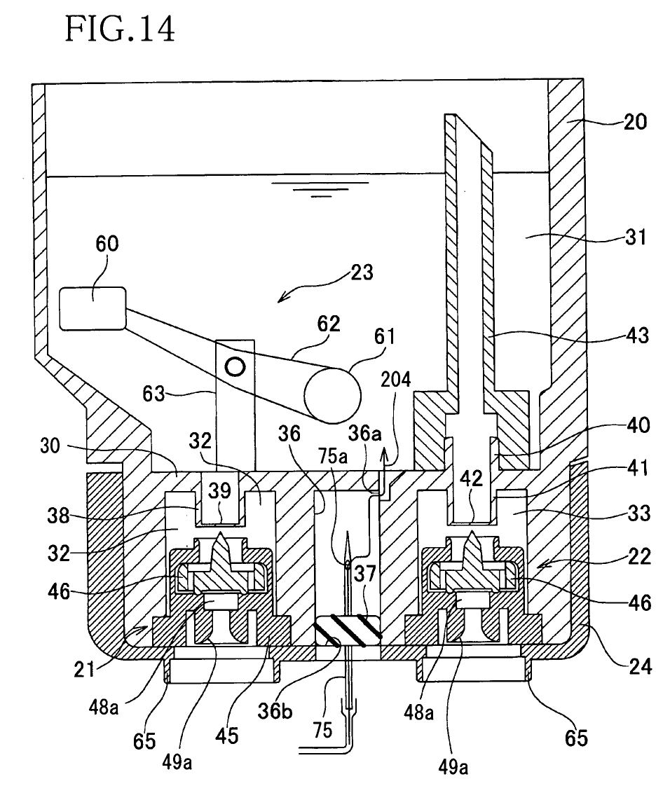

A further embodiment of the invention is described with reference to FIGS. 12-14, which depict an exemplary method of filling with respect to an ink cartridge 3, which has a configuration similar or the same as the ink cartridge 3 shown in FIGS. 7-11. Accordingly, like reference numerals are used and description of like features is omitted in the interest of brevity.

As shown in FIG. 12, the ink cartridge 3 in which the ink chamber 31 has become empty is removed from the holder 4. The ink cartridge 3 is placed with an opening of the tubular member 43 that communicates with the ink chamber 31 face up. One end of a pump tube 91a, which is connected to a pump 91 at the other end, is inserted into the guide hole 49a of the air communication valve 22 in a direction of an arrow 201, so that the air communication valve 22 is opened. Then, the plug member 37, disposed so as to seal the opening 36a of the ink fill hole 36, is separated away from the opening 36a in the direction of the arrow 202 and is disposed near the opening 36b. Using the pump 91, air in the ink chamber 31 is suctioned until pressure is reduced to a specified value. When pressure reduction of the ink chamber 31 is completed, the pump tube 91a is pulled out from the guide hole 49a.

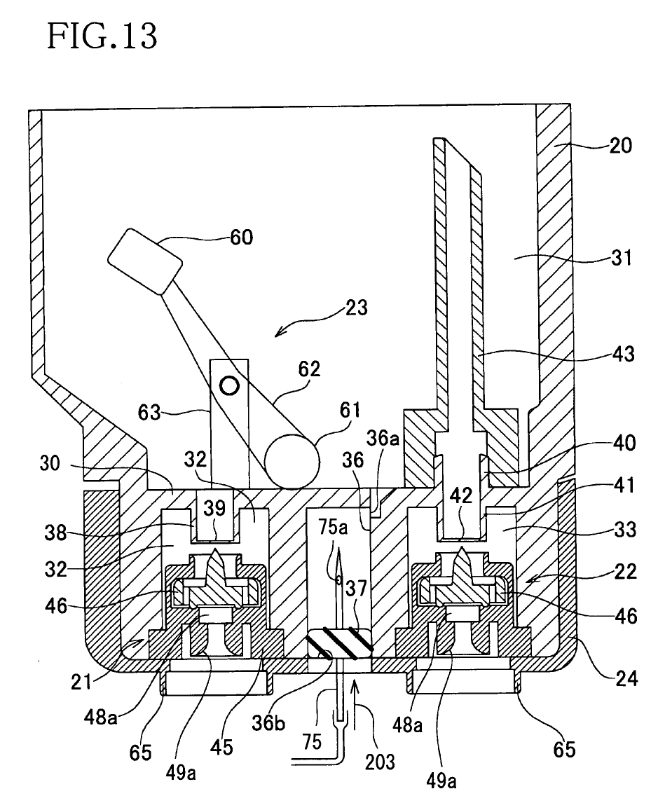

A shown in FIG. 13, an injection needle 75 connected to an ink tank for ink filling (not shown) is inserted into the plug member 37 in a direction of an arrow 203 such that the injection needle 75 passes through and is exposed from the top surface of the plug member 37. At this time, the injection needle 75 should be inserted until an ink outlet 75a formed near the tip of the injection needle 75 is located at a position completely through the plug member 37 and toward the ink chamber 31. As the ink chamber 31 is under reduced pressure, ink in the ink tank for filling passes through the inside of the injection needle 75, through the plug member 37 and is discharged in the ink fill hole 36 from the ink outlet 75a. The introduced ink flows into the ink chamber 31 through the opening 36a of the ink fill hole 36 (in a direction of an arrow 204). When the ink chamber 31 is full of ink, pressure in the ink chamber reaches a specified value and ink filling is stopped. In embodiments, ink filling is stopped while the ink chamber 31 is kept under a negative pressure.

Then, the injection needle 75 is pulled out from the plug member 37. At this time, a through hole, which is formed in the plug member 37 after the injection needle 75 is inserted, is closed by the elastic force of the plug member 37. Thereafter, the plug member 37 disposed near the opening 36b is moved up to the upper end of the ink fill hole 36 in a direction of an arrow 106 so as to seal the opening 36a at its peripheral side surface. This completes ink filling.

By employing the exemplary method shown in FIGS. 12-14, the ink chamber 31 can be easily filled without modification to the cartridge body 20. In embodiments, ink filling is stopped while the ink chamber 31 is kept under a negative pressure. Accordingly, air present in ink can be controlled, and ink ejection properties of the ink can be maintained stably for long periods.

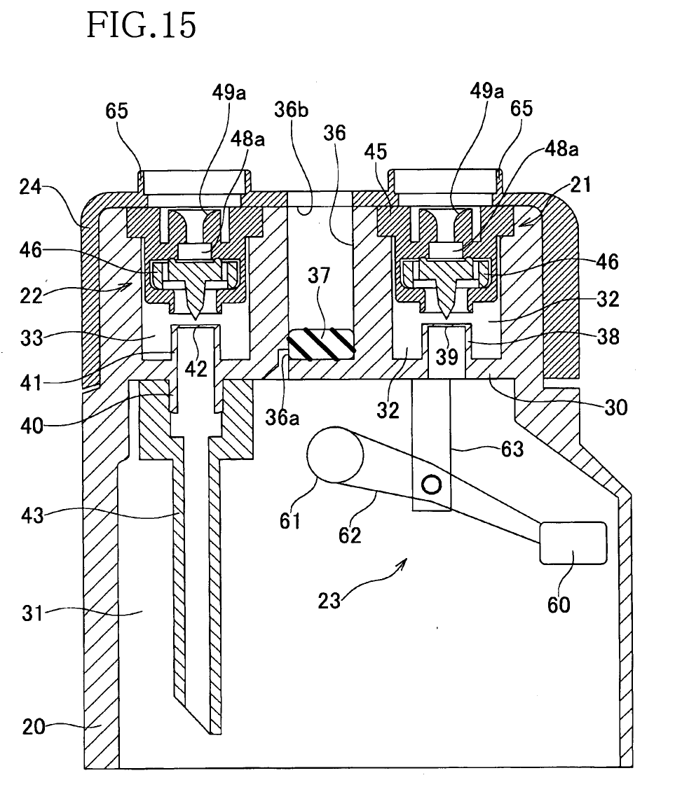

A further embodiment of the invention is described with reference to FIGS. 15-19, which depict an exemplary method of filling with respect to an ink cartridge 3, which has a configuration similar or the same as the ink cartridge 3 shown in FIGS. 7-14. Accordingly, like reference numerals are used and description of like features is omitted in the interest of brevity.

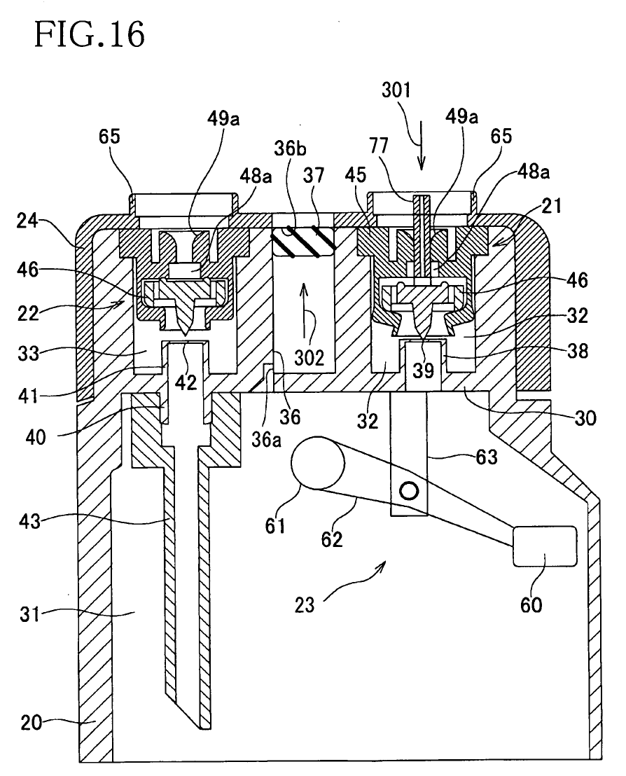

As shown in FIG. 15, the ink cartridge 3 in which the ink chamber 31 has become empty is removed from the holder 4. To prevent ink from flowing in the valve chamber 32 when ink is filled into the ink chamber 31, the removed ink cartridge 3 is placed with the valve chamber 32 positioned up. As shown in FIG. 16, the air ventilation tube 77, is inserted into the guide hole 49a of the ink supply valve 21 in a direction of an arrow 301, so that the ink supply valve 21 is open. Then, the plug member 37 disposed so as to seal the opening 36a of the ink fill hole 36 is separated away from the opening 36a in a direction of an arrow 302 and is disposed near the opening 36b.

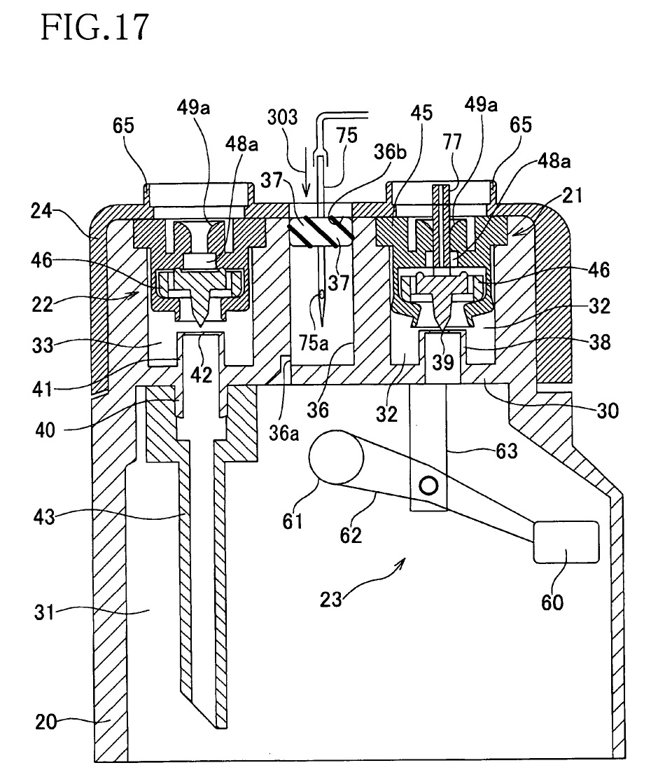

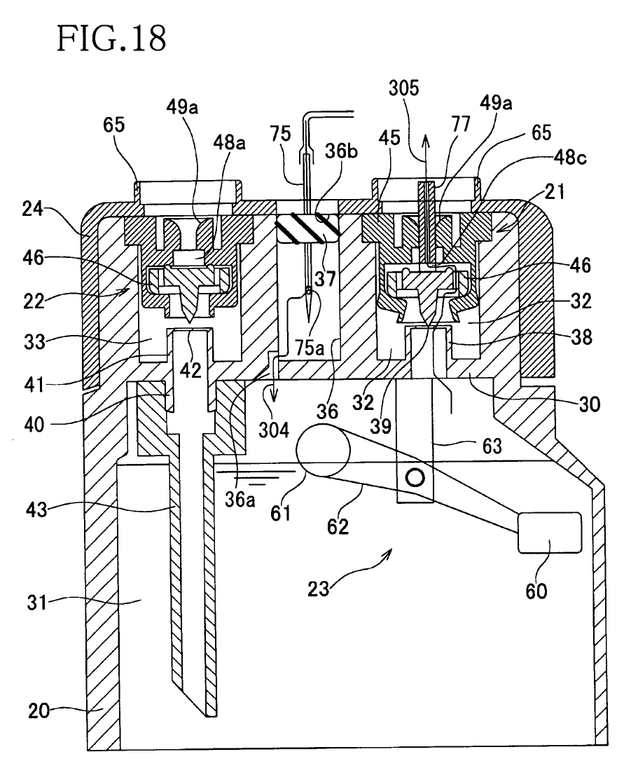

As shown in FIG. 17, the injection needle 75 of an ink syringe (not shown) is inserted into the plug member 37 in a direction of an arrow 303 such that the injection needle 75 passes through the plug member 37. At this time, the injection needle 75 should be inserted until the ink outlet 75a formed near the tip of the injection needle 75 is located toward the ink chamber 31 completely through the plug member 37. That is, the ink outlet 75a should be located nearer the ink chamber 31 than the plug member 37 is. Then the ink syringe is operated such that ink is introduced into the ink chamber 31. As shown in FIG. 18, the introduced ink passes through the inside of the injection needle 75, through the plug member 37 and is discharged in the ink fill hole 36 from the ink outlet 75a. Further, the introduced ink flows in the ink chamber 31 from the opening 36a of the ink fill hole 36 (in a direction of an arrow 304). At this time, as shown by an arrow 305, air in the ink chamber 31 is discharged outside through the ink supply valve 21 in accordance with an amount of the introduced ink. When ink is filled into the ink chamber 31, the ink filling by the ink syringe is stopped.

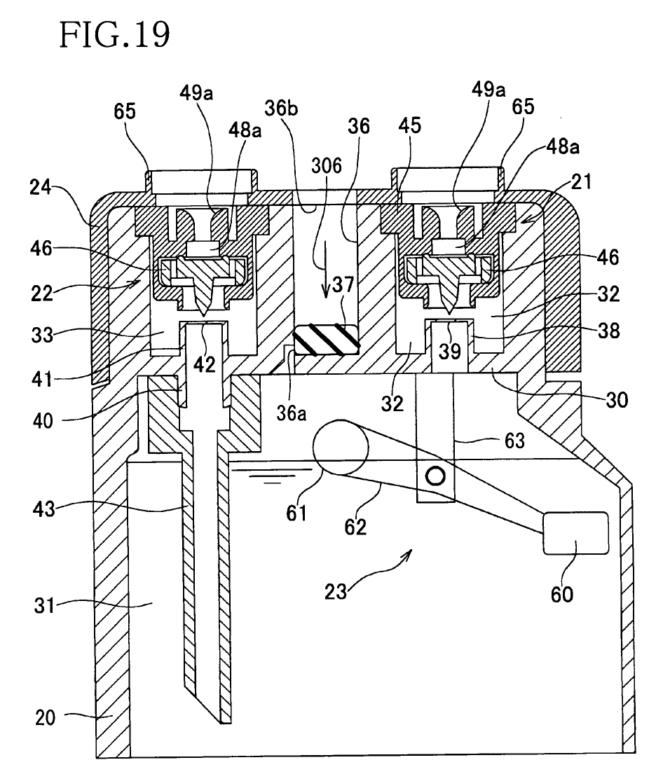

As shown in FIG. 19, the injection needle 75 is pulled out from the plug member 37. At this time, a through hole, which is formed in the plug member 37 after the injection needle 75 is inserted, is closed by itself due to elastic force exerted by the plug member 37. Thereafter, the plug member 37 disposed near the opening 36b is moved down to the lower end of the ink fill hole 36 in a direction of an arrow 306 so as to seal the opening 36a at its peripheral side surface. When sealing of the opening 36a is completed, the air ventilation tube 77 is pulled out from the guide hole 49a of the ink supply valve 21, the ink supply valve 21 is closed, and the ink filling is completed.

In the embodiment shown in FIGS. 15-19, the ink chamber 31 can be easily filled without modification to the cartridge body 20. Ink is introduced in accordance with the amount of air discharged outside through the air ventilation tube 77. Thereby, substantially the entire of the volume of the ink chamber 31 can be filled with ink, so that ink filling efficiency is high.

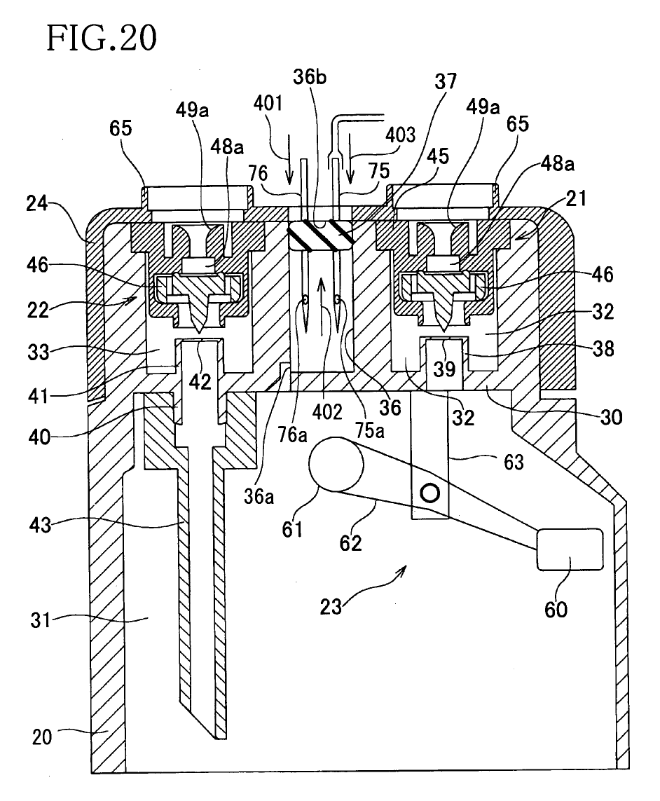

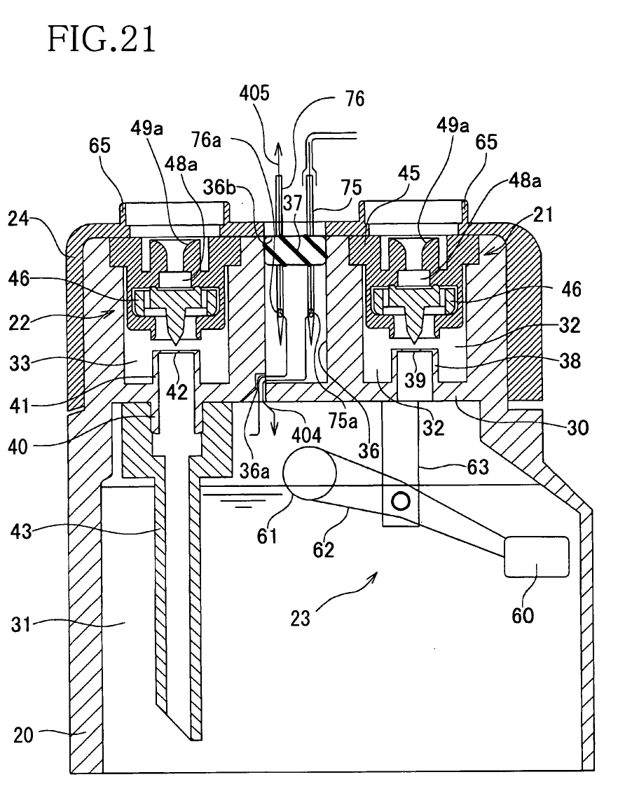

A further embodiment of the invention is described with reference to FIGS. 20 and 21, which depict an exemplary method of filling with respect to an ink cartridge 3, which has a configuration similar or the same as the ink cartridge 3 shown in FIGS. 7-19. Accordingly, like reference numerals are used and description of like features is omitted in the interest of brevity.

As shown in FIG. 20, the ink cartridge 3 in which the ink chamber 31 has become empty is removed from the holder 4. To prevent ink from flowing in the ink fill hole 36 when the ink chamber 31 is filled, the removed ink cartridge 3 is placed with the opening 36a of the ink fill hole 36 positioned up. As shown in FIG. 20, the plug member 37 positioned so as to seal the opening 36a of the ink fill hole 36 is separated away from the opening 36a in a direction of an arrow 402 and disposed near the opening 36b.

A ventilation needle 76 for communication with air is inserted into the plug member 37 in a direction of an arrow 401 such that the ventilation needle 76 passes through the bottom surface of the plug member 37. At this time, the ventilation needle 76 should be inserted until a communication hole 76a formed near the tip of the ventilation needle 76 is located completely through the plug member 37 toward the ink chamber 31. That is, the communication hole 76a should be located nearer the ink chamber 31 than the plug member 37 is. In addition, the injection needle 75 of an ink syringe (not shown) is inserted into the plug member 37 such that the injection needle 75 passes through the bottom surface of the plug member 37 (in a direction of an arrow 403). At this time, the injection needle 75 should be inserted until the ink outlet 75a formed near the tip of the injection needle 75 is located completely through the plug member 37 toward the ink chamber 31. That is, the ink outlet 75a should be located nearer the ink chamber 31 than the plug member 37 is. Then the ink syringe is operated such that ink is introduced into the cartridge body 20. As shown in FIG. 21, the introduced ink passes through the inside of the injection needle 75, through the plug member 37 and is introduced in the ink fill hole 36 from the ink outlet 75a. Further, the thus introduced ink flows in the ink chamber 31 from the opening 36a of the ink fill hole 36 (in a direction of an arrow 404). At this time, as shown by an arrow 405, air in the ink chamber 31 corresponding to an amount of the introduced ink passes through the inside of the ventilation needle 76 and flows outside. When the ink chamber 31 is full, filling with the ink syringe is stopped.

Then, the ventilation needle 76 and the injection needle 75 are pulled out from the plug member 37. At this time, through holes, which are formed in the plug member 37 after the ventilation needle 76 and the injection needle 75 are inserted, are closed by elastic force exerted by the plug member 37. Thereafter, the plug member 37 disposed near the opening 36b is moved down to the lower end of the ink fill hole 36 so as to seal the opening 36a at its peripheral side surface. This completes ink filling.

According to the embodiment shown in FIGS. 20 and 21, the ink chamber 31 can be easily filled with ink without modification of the cartridge body 20. It is preferable that, during ink filling, the communication hole 76a is disposed near the plug member 37 and the ink outlet 75a is disposed near the opening 36a. With this arrangement, the amount of ink to be introduced into the ink chamber 31 can be increased.

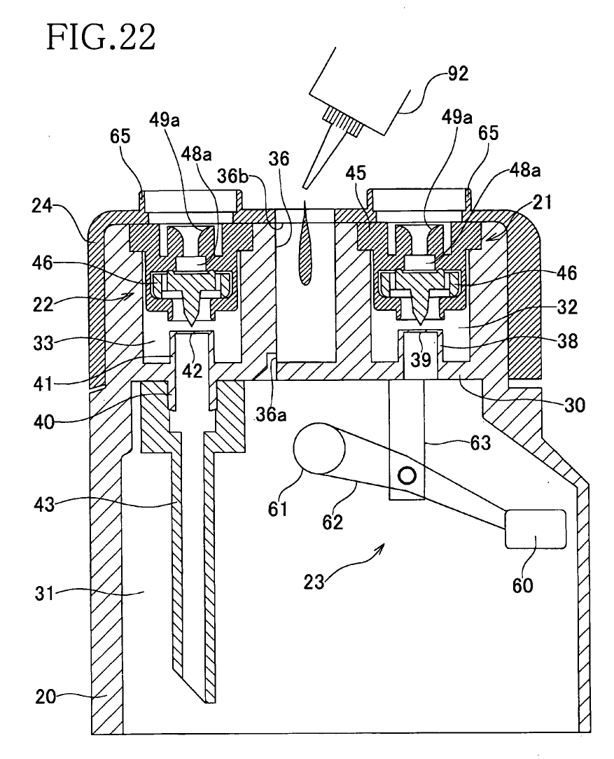

A further embodiment of the invention is described with reference to FIG. 22, which depicts an exemplary method of filling with respect to an ink cartridge 3, which has a configuration similar or the same as the ink cartridge 3 shown in FIGS. 7-21. Accordingly, like reference numerals are used and description of like features is omitted in the interest of brevity.

The ink cartridge 3 in which the ink chamber 31 has become empty is removed from the holder 4. To prevent ink from flowing in the ink fill hole 36 when ink is filled into the ink chamber 31, the removed ink cartridge 3 is placed with the opening 36a of the ink fill hole 36 face up. Then, as shown in FIG. 22, the plug member 37 disposed so as to seal the opening 36a of the ink fill hole 36 is removed. Ink stored in an ink tank 92 for ink filling is directly introduced into the ink fill hole 36 from the opening 36b. The introduced ink drips off into the ink chamber 31 via the opening 36a of the ink fill hole 36. Then, the plug member 37 is positioned at the lower end of the ink fill hole 36 so as to seal the opening 36a. This completes ink filling. The plug member 37 may be reused or replaced with a new plug member 37.

The embodiment shown in FIG. 22 permits the ink chamber 31 to be filled without modification to the cartridge body 20.

In the various exemplary embodiments described above, for the purpose of providing an ink cartridge having longevity and that promotes good ink ejection properties, it is preferable to add a step where the pressure of the ink chamber 31 is reduced to a negative pressure by opening at least one of the ink supply valve 21 and the air communication valve 22, after filling is complete. With this step, air remaining in the ink chamber 31 and each passage can be largely eliminated, so air will be less likely to be dissolved or dispersed in the ink. Thus, even when the ink cartridge is used after it has been stored for a long time, ink that is deaerated and free from air bubbles can be supplied to the inkjet head 2.

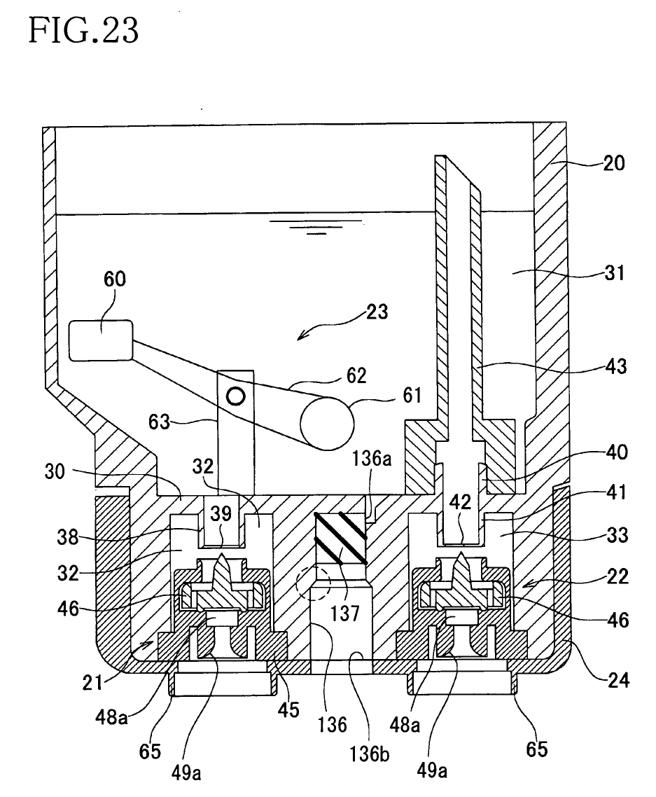

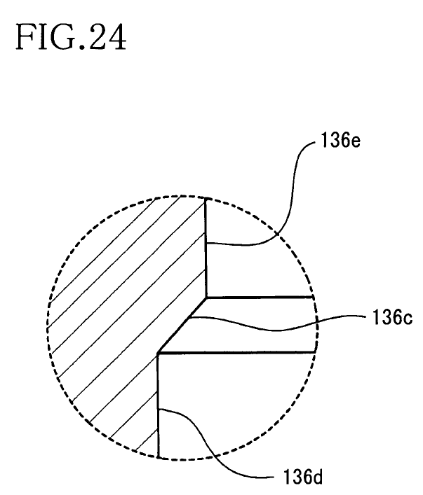

In the embodiments described above, the ink fill hole 36 has a tubular shape, however, the shape of the ink fill hole 36 is not so limited. A variation in ink fill hole structure is described with reference to FIGS. 23 and 24.

As shown in FIG. 23, an ink fill hole 136 that extends vertically for filling ink into an empty ink chamber 31 is formed between the two valve chambers 32, 33. As shown in FIG. 24, a stepped portion 136c is formed in a middle of the ink fill hole 136. At the stepped portion 136c, the ink fill hole 136 is divided into a large-diameter hole 136d on an entrance side and a small-diameter hole 136e having a diameter smaller than the large-diameter hole 136d. The large-diameter hole 136d and the small-diameter hole 136e are each formed in a substantially straight shape such that their respective hole diameters are substantially consistent along their lengths.

At an end portion of the small-diameter hole 136e of the ink fill hole 136, an opening 136a that provides communication between the ink fill hole 136 and the ink chamber 31 is formed near an edge portion on which the sidewall surface and the inner end surface intersect. An opening 136b is provided at an opposite end of the ink fill hole 136, through which the ink fill hole 136 communicates with an outside of ink cartridge 3. A synthetic rubber plug member 137 having elasticity is force-fitted into the small-diameter hole 136e of the ink fill hole 136, and the top surface of the plug member 137 makes contact with the inner end surface of the small-diameter hole 136e. Thus, the opening 136a, formed at the corner of the end portion of the ink fill hole 136, is sealed by the plug member 137 with reliability.

By employing such a configuration, during sealing, when the plug member 137 is moved to the small-diameter hole 136e, the plug member 137 is compressed at its peripheral side surface. Thus, the density of the plug member 137 is increased and the opening 136a, formed at the corner of the end portion of the ink fill hole 136, can be sealed with reliability even if numerous through holes are formed in the plug member 137 as a result of repeated insertions of the injection needle 75 into the plug member 137. From the viewpoint of improving the sealing effectiveness of the plug member 137, it is possible to form the small-diameter hole 136e to have a conical shape so as to be narrower at an end nearest to the ink chamber 31.

Although the invention has been described with reference to particular ink cartridge configurations, it should be appreciated that the methods described herein are applicable to other configurations. For example, an ink fill hole 36 structured so that the plug member 37 is movable between the opening 36a and the opening 36b is described above. However, the ink fill hole 36 is not limited to this structure. The plug member 37 may be immovable.

In the embodiments described above, the plug member 37 seals the opening 36a at its peripheral side surface and the injection needle 75 passes through the plug member 37 and is exposed from the top surface thereof. However, the plug member 37 may seal the opening at its peripheral side surface and the injection needle 75 may pass through the plug member 37 and be exposed from the peripheral side surface of the plug member 37. Additionally, the plug member 37 may seal the opening at its top or bottom surface and the injection needle 75 may pass through the plug member 37 and be exposed from the top or bottom surface of the plug member 37.

Further, in the embodiments described above, the injection needle 75 is inserted into the plug member 37 until the ink outlet 75a formed near the tip of the injection needle 75 is located toward the ink chamber 31. However, the invention is not limited to this structure. The needle 75 may be inserted into the plug member 37 so that the ink outlet 75a is directly located in the ink chamber 31.

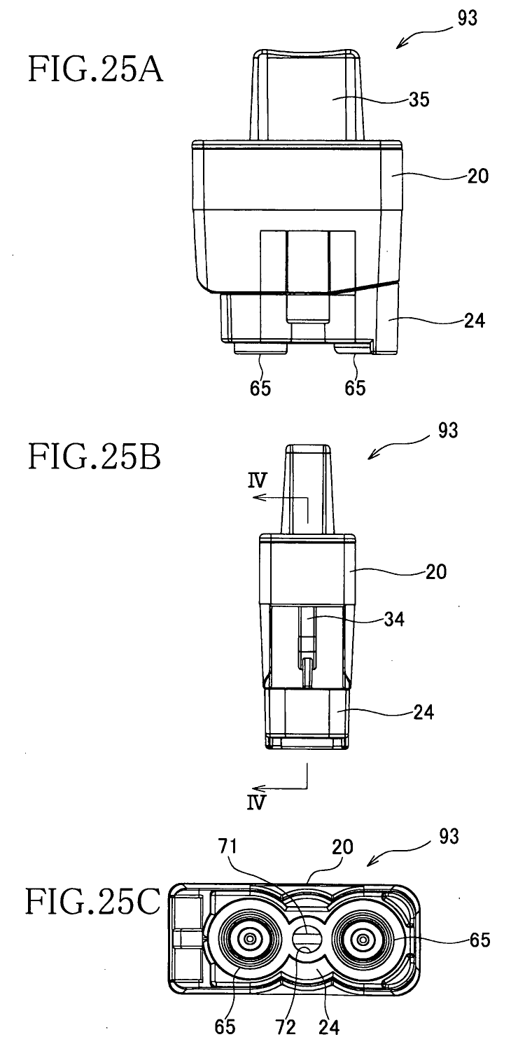

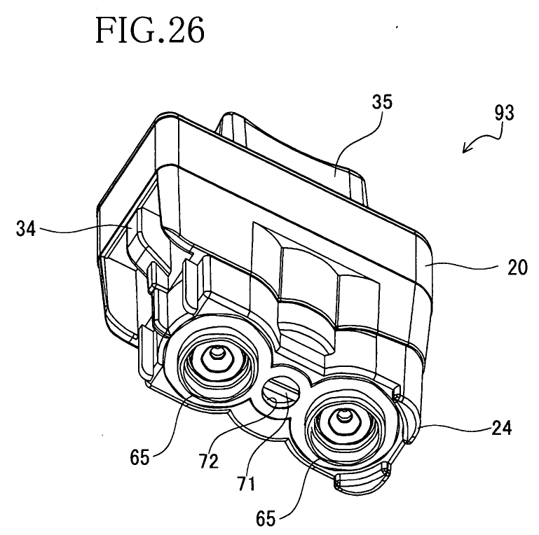

An exemplary ink cartridge is described with reference to FIGS. 25-28. It is noted that for elements of the ink cartridge 93 that are similar to or identical with the elements of the ink cartridge 3 described above and designated by similar numerals, the description thereof may be omitted for the sake of brevity.

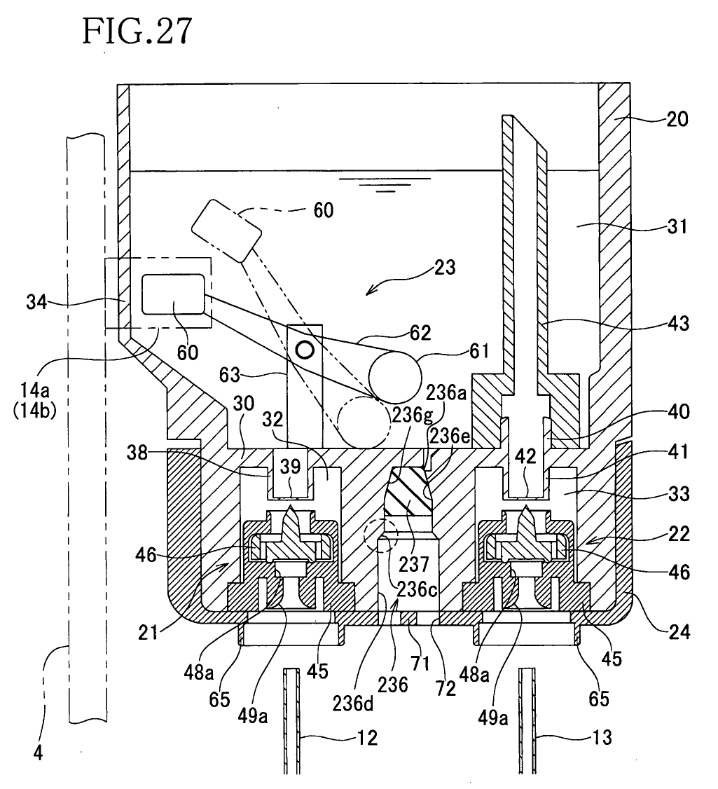

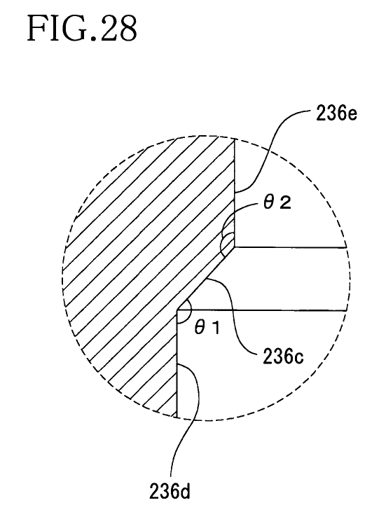

As shown in FIG. 27, an ink fill hole 236 that extends vertically for filling ink into an empty ink chamber 31 is formed between the two valve chambers 32, 33. A stepped portion 236c is formed in the middle of the ink fill hole 236. As shown in FIG. 28, the ink fill hole 236 is divided into a large-diameter hole 236d on an entrance side and a small-diameter hole 236e of which diameter is smaller than the large-diameter hole 236d at the stepped portion 236c. The large-diameter hole 236d is formed in straight shape where hole diameter is unchanged. The small-diameter hole 236e is formed in straight shape where hole diameter is unchanged in its lower portion (on the entrance side) and is formed in a truncated cone shape at an end portion 236g.

At the end portion 236g of the small-diameter hole 236e of the ink fill hole 236, an opening 236a that provides communication between the ink fill hole 236 and the ink chamber 31 is formed near an edge portion on which the sidewall surface and the inner end surface intersect. An opening 236b is provided at an opposite end of the ink fill hole 236, through which the ink fill hole 236 communicates with an outside of ink cartridge 93. A synthetic rubber plug member 237 having elasticity is force-fitted into the small-diameter hole 236e of the ink fill hole 236, and the top surface of the plug member 237 makes contact with the inner end surface of the small-diameter hole 236e. Thus, the opening 236a, formed at the corner of the end portion 236g of the ink fill hole 236, is sealed by the plug member 237 with reliability.

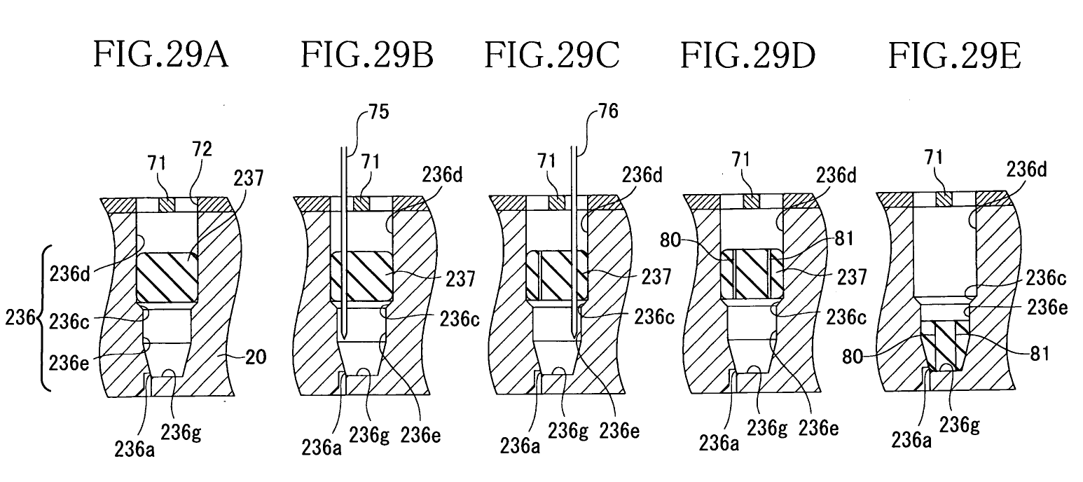

An injection needle 75 (FIG. 29) of an ink syringe may be inserted through the plug member 237 inside the ink fill hole 236, and ink may be introduced via the injection needle 75 into the ink chamber 31. An exemplary method of filling the ink cartridge 93 will be described in detail below. As shown in FIG. 28, angles θ1 and θ2 are formed between the stepped portion 236c and the large-diameter hole 236d and between the stepped portion 236c and the small-diameter hole 236e, respectively. The angles θ1 and θ2 are not right angles but rather obtuse angles. With this structure, when the plug member 237 is force-fitted into the small-diameter hole 236e via the large-diameter hole 236d after the ink chamber 31 is filled with ink, resistance acting on the plug member 237 is relatively small.

As shown in FIGS. 25A, 25B, 25C, 26 and 27, at a bottom portion of the cap 24, an inlet 72 having the same diameter size of the ink fill hole 236 is provided at a position corresponding to an entrance of the ink fill hole 236 of the ink cartridge 93. A partition portion 71 is also formed at the bottom portion of the cap 24. The partition portion 71 passes through the center of the inlet 72 to divide an entrance of the inlet 72 into two. When ink is introduced into the ink chamber 31, the injection needle 75 is inserted into one entrance and a ventilation needle 76 for deaeration from ink is inserted into the other entrance (FIG. 29), as described below. The partition portion 71 prevents the plug member 237 from being removed from the ink fill hole 236.

An exemplary method of filling the ink cartridge 93 is described with reference to FIGS. 29A through 29E. As shown in FIG. 29A, the plug member 237 is moved to the large-diameter hole 236d on the entrance side of the ink fill hole 236 of the cartridge body 20 of which ink chamber 31 has become empty. Air in the cartridge body 20 is ejected via the ink supply valve 21 or the air communication valve 22 so as to create a specified negative pressure in the cartridge body 20. Decompression to the specified pressure may be conducted to such an extent that a required amount of ink can be filled in a later step.

As shown in FIG. 29B, the injection needle 75 is inserted through the plug member 237 at the large-diameter hole 236d from one entrance of the ink fill hole 236 divided by the partition portion 71, which is formed at the cap 24. Ink is introduced from the opening 236a via the injection needle 75 into the ink chamber 31, which has been decompressed under a negative pressure. When a specified amount of ink is filled into the ink chamber 31, the injection needle 75 is removed from the plug member 237.

When ink is supplied to the ink cartridge 93, air in the ink passages formed at the inkjet head 2 may be dissolved or dispersed into the ink, with the result that air bubbles may be formed in use. To prevent formation of air bubbles, air present in the ink introduced into the cartridge body 20 is ejected. That is, as shown in FIG. 29C, the ventilation needle 76 is inserted into the plug member 237 at the large-diameter hole 236d from the other entrance of the ink fill hole 236, and air remaining in the cartridge body 20 is ejected via the needle 76. As shown in FIG. 29D, by inserting the injection needle 75 and the ventilation needle 76 from the two entrances divided by the partition portion 71 respectively, through holes 80, 81 that are produced in the plug member 237 at the insertion can be made small. Thus, ink is less likely to leak from the through holes 80, 81 outside, and air and impurities are prevented from entering the cartridge body 20. In addition, the needles 75 and 76 are repeatedly inserted in the same places of the plug member 237. This prevents the plug member 237 from sustaining damage that may cause flakes of the plug member 237 to mix with the ink. That is, the cleanness of the ink can be maintained.

After deaeration is completed, as shown in FIG. 29E, the plug member 237 is force-fitted into the small-diameter hole 236e further inward from the stepped portion 236c until it is in contact with an inner end surface of the end portion 236g of the small-diameter hole 236e formed in the truncated cone shape. As the plug member 237 is thus force-fitted via the large-diameter hole 236d into the small-diameter hole 236e, which is smaller in diameter size than the large-diameter hole 236d, the plug member 237 is greatly compressed by a sidewall surface of the small-diameter hole 236e, and the through holes 80, 81, which are produced in the plug member 237 when the needles 75, 76 are inserted, close with reliability. The opening 236a that provides communication between the ink chamber 31 and the ink fill hole 236 is formed near the edge portion on which the sidewall surface and the inner end surface intersect. Thus, the opening 236a is sealed with reliability by the plug member 237, which makes contact with the inner end surface of the end portion 236g. The injection needle 75 and the ventilation needle 76 are generally inserted into the plug member 237 at positions closer to the center (central axis) of the plug member 237 than the edge thereof. In this case, in a plan view, the opening 236a that is formed at the corner of the end portion 236g of the ink fill hole 236 and the through holes 80, 81 that are formed at the plug member 237 are spaced away from each other. Thus, the opening 236a can be securely sealed up by the plug member 237 regardless of the size of the through holes 80, 81.

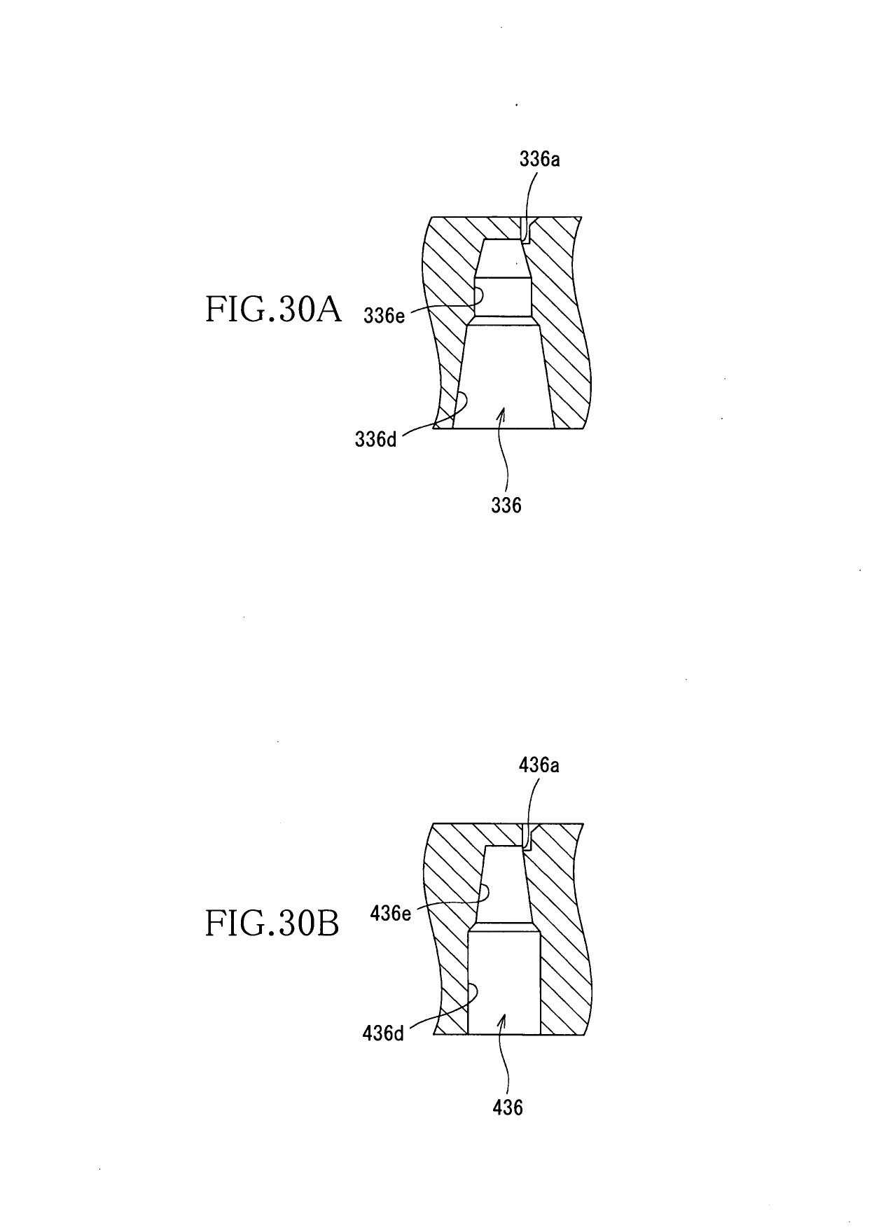

The shape of the ink fill hole is not limited to the above-described shape. The ink fill hole may be formed in any shape as long as it includes a stepped portion that forms the boundary between a hole on the entrance side of the ink fill hole and a hole on the inner side of the ink fill hole of which diameter is smaller than that of the hole on the entrance side. For example, as shown in FIG. 30A, an ink fill hole 336 that includes a small-diameter hole 336e formed in a straight shape and a large-diameter hole 336d formed in a truncated cone shape may be used. Alternatively, as shown in FIG. 30B, an ink fill hole 436 that includes a large-diameter hole 436d formed in a straight shape and a small-diameter hole 436e formed in a truncated cone shape maybe used. Further, an ink fill hole may have one or more stepped portions.

The shape of the partition portion that divides the entrance of the ink fill hole is not limited to the above-described shape. For example, the partition portion may extend horizontally and radially from the axis of the ink fill hole such as to divide the entrance of the ink fill hole into three or more sections. In addition, if deaeration is not performed after ink is filled into the ink chamber 31, there is no need to divide the entrance of the ink fill hole, because the injection needle 75 only passes through the plug member 237. In this case, the partition portion may be omitted.

While this invention has been described in conjunction with the exemplary embodiments outlined above, various alternatives, modifications, variations, improvements and/or substantial equivalents, whether known or that are or may be presently unforeseen, may become apparent to those having at least ordinary skill in the art. Accordingly, the exemplary embodiments of the invention, as set forth above, are intended to be illustrative, not limiting. Various changes may be made without departing from the spirit and scope of the invention. Therefore, the invention is intended to embrace all known or later developed alternatives, modifications, variations, improvements and/or substantial equivalents.

1. A method of filling an ink cartridge having a cartridge body including an ink tank, an ink inflow passage that communicates with the ink tank at a first end through a first opening and that communicates with an exterior of the ink cartridge at a second end through a second opening, and a sealing member that is positioned in the ink inflow passage, the method comprising:
reducing a pressure in the ink tank;
inserting an ink supply tube through the sealing member and into a first region in the ink inflow passage adjacent to the first opening; and
allowing ink to be drawn through the ink supply tube, through the first opening, and into the ink tank.

2. The method of claim 1, further comprising moving the sealing member from the first region to a second region in the ink inflow passage adjacent to the second opening before inserting the ink supply tube.

3. The method of claim 2, further comprising:
removing the ink supply tube from the ink inflow passage; and
moving the sealing member from the second region to the first region;
wherein moving the sealing member from the second region to the first region comprises moving the sealing member into a position such that a surface of the sealing member seals the first opening, the surface being a surface that has not been penetrated by the ink supply tube.

4. The method of claim 1, wherein the ink supply tube is a syringe needle and the sealing member is formed of a material having an elasticity such that a hole formed by the syringe needle will tend to close itself when the syringe needle is removed.

5. A method of filling an ink cartridge having a cartridge body including an ink tank, an ink inflow passage that communicates with the ink tank at a first end through a first opening and that communicates with an exterior of the ink cartridge at a second end through a second opening, and a sealing member that is positioned in the ink inflow passage, the method comprising:
opening a communication path to allow communication between the ink tank and the exterior of the ink cartridge;
inserting an ink supply tube through the sealing member and into a first region in the ink inflow passage adjacent to the first opening; and
introducing ink through the ink supply tube, through the first opening, and into the ink tank.

6. The method of claim 5, further comprising positioning the ink cartridge so that ink is prevented from flowing into the communication path when the ink is introduced into the ink tank.

7. The method of claim 5, further comprising moving the sealing member from the first region to a second region in the ink inflow passage adjacent to the second opening before inserting the ink supply tube.

8. The method of claim 7, further comprising:
removing the ink supply tube from the ink inflow passage; and
moving the sealing member from the second region to the first region;
wherein moving the sealing member from the second region to the first region comprises moving the sealing member into a position such that a surface of the sealing member seals the first opening, the surface being a surface that has not been penetrated by the ink supply tube.

9. The method of claim 5, wherein the ink supply tube is a syringe needle and the sealing member is formed of a material having an elasticity such that a hole formed by the syringe needle will tend to close itself when the syringe needle is removed.

10. The method of claim 5, wherein opening the communication path comprises opening a valve situated in an air communication chamber in the cartridge body.

11. The method of claim 5, wherein opening the communication path comprises opening a valve situated in an ink outflow chamber in the cartridge body.

12. A method of filling an ink cartridge having a cartridge body including an ink tank, an ink inflow passage that communicates with the ink tank at a first end through a first opening and that communicates with an exterior of the ink cartridge at a second end through a second opening, and a sealing member that is positioned in the ink inflow passage, the method comprising:
inserting an air communication tube through the sealing member and into a first region in the ink inflow passage adjacent to the first opening;
inserting an ink supply tube through the sealing member and into the first region; and
introducing ink through the ink supply tube, through the first opening, and into the ink tank.

13. The method of claim 12, further comprising moving the sealing member from the first region to a second region in the ink inflow passage adjacent to the second opening before inserting the air communication tube and the ink supply tube.

14. The method of claim 13, further comprising:
removing the air communication tube and the ink supply tube from the ink inflow passage; and
moving the sealing member from the second region to the first region;
wherein moving the sealing member from the second region to the first region comprises moving the sealing member into a position such that a surface of the sealing member seals the first opening, the surface being a surface that has not been penetrated by the air communication tube or the ink supply tube.

15. The method of claim 12, wherein the air communication tube and the ink supply tube are a syringe needles and the sealing member is formed of a material having an elasticity such that holes formed by the syringe needles will tend to close themselves when the syringe needles are removed.

16. A method of filling an ink cartridge having a cartridge body including an ink tank, an ink inflow passage that communicates with the ink tank at a first end through a first opening and that communicates with an exterior of the ink cartridge at a second end through a second opening, and a sealing member that is positioned in the ink inflow passage, the method comprising:
removing the sealing member from the ink inflow passage; and
dispensing ink into the ink inflow passage, through the first opening, and into the ink tank.

17. The method of claim 16, further comprising replacing the sealing member into the ink inflow passage.

18. A method of filling an ink cartridge having a cartridge body including an ink tank, and an ink inflow passage that communicates with the ink tank at a first end through a first opening and that communicates with an exterior of the ink cartridge at a second end through a second opening, the ink inflow passage including a first region adjacent to the first end having a smaller diameter than a second region adjacent to the second end, the method comprising:
disposing a sealing member in the second region of the ink inflow passage;
opening an air communication path between the ink tank and an exterior of the ink cartridge;
inserting an ink supply tube through the sealing member and into the first region;
introducing ink through the ink supply tube and into the ink tank;
removing the ink supply tube from the ink inflow passage; and
moving the sealing member from the second region to the first region.

19. The method of claim 18, wherein moving the sealing member from the second region to the first region comprises moving the sealing member into a position such that a surface of the sealing member seals the first opening, the surface being a surface that has not been penetrated by the ink supply tube.

20. The method of claim 18, wherein the ink supply tube is a syringe needle and the sealing member is formed of a material having an elasticity such that a hole formed by the syringe needle will tend to close itself when the syringe needle is removed.

21. The method of claim 18, wherein the first region has a truncated conical shape and moving the sealing member from the second region to the first region comprises moving the sealing member into the first region so that it contacts an end surface of the ink inflow passage opposite from the second opening.

22. An ink cartridge, comprising:
a cartridge body;
an ink tank formed in the cartridge body for storing ink; and
an ink inflow passage formed in the cartridge body for filling the cartridge;
wherein:
the ink inflow passage communicates with the ink tank at a first end through a first opening and communicates with an exterior of the cartridge at a second end through a second opening;
the ink inflow passage includes a first region adjacent to the first opening and a second region adjacent to the second opening; and
the first region has a smaller diameter than the second region.

23. The ink cartridge of claim 22, wherein at least one of the first region and the second region has a tapered shape, such that the region has a greater diameter at an end closer to the second opening than to the first opening.

24. The ink cartridge of claim 22, further comprising a stepped portion between the first region and the second region.

25. The ink cartridge of claim 24, wherein a first angle between the first region and the stepped portion and a second angle between the second region and the stepped portion are obtuse.

26. The ink cartridge of claim 22, wherein the second opening is partitioned into multiple openings.

27. The ink cartridge of claim 22, wherein the ink inflow passage includes a side wall and an end surface, the first region is provided in a truncated conical shape, and the first opening is provided on the side wall at a location adjacent to the end surface.
